(19) United States
(12) Patent Application Publication
(10) Pub. No.: US 2022/0417731 A1
(43) Pub. Date: Dec. 29, 2022

(54) CONTROL DEVICE, BASE STATION DEVICE, CONTROL METHOD, AND CONNECTION METHOD

(71) Applicant: SONY GROUP CORPORATION, TOKYO (JP)

(72) Inventors: SHINICHIRO TSUDA, TOKYO (JP); HIROAKI TAKANO, KANAGAWA (JP)

(21) Appl. No.: 17/756,432

(22) PCT Filed: Oct. 21, 2020
(86) PCT No.: PCT/JP2020/039475

§ 371 Date: May 25, 2022

(30) Foreign Application Priority Data
Dec. 6, 2019 (JP) 2019-221510

(51) Int. Cl. H04W 8/24; H04L 47/2416; H04W 36/12; H04W 28/02

(52) U.S. Cl. CPC H04W 8/24; H04L 47/2416; H04W 36/12; H04W 28/0236

(57) ABSTRACT

A control device (223) according to the present disclosure is a control device connected to a plurality of processing devices (240) and a base station device (260) via a network (20). The control device (223) includes a control unit (2233). The control unit (2233) acquires information regarding processing capabilities of the plurality of processing devices (240). The control unit (2233) selects a processing device (2403) that is to execute at least one function of a core network (225) connected to the base station device (260) from among the plurality of processing devices (240) based on the acquired information regarding the processing capabilities.

### FIELD

The present disclosure relates to a control device, a base station device, a control method, and a connection method.

### BACKGROUND

In recent years, with the spread of a network function virtualization (NFV) technology and the demand for cost reduction of a core network, a movement to commercialize a cloud-based core network has started to appear. For example, a technology for constructing a virtual core network in a data center of a cloud service provider has been known.

### CITATION LIST

### Patent Literature

Patent Literature 1: JP 2019-57929 A

### SUMMARY

### Technical Problem

Meanwhile, ultra-reliable and low latency communications (URLLC) is one of features of the 5th generation mobile communication system (5G). In order to realize this low latency communication, not only low latency in communication between a base station device and a terminal device is required, but also low latency in a system including a core network is required.

Also in a case of constructing the virtual core network described above, it is required to reduce the latency in a system including the virtual core network. However, for example, in the virtual core network constructed across different networks via the Internet, there is a possibility that it is not possible to satisfy a demand for reduction in latency only by simply constructing the virtual core network in the data center of the cloud service provider.

Therefore, the present disclosure proposes a mechanism for constructing a virtual core network with lower latency.

### Solution to Problem

In order to solve said problem, a control device according to an embodiment of the present disclosure is a control device connected to a plurality of processing devices and a base station device via a network. The control device includes a control unit. The control unit acquires information regarding processing capabilities of the plurality of processing devices. The control unit selects a processing device that is to execute at least one function of a core network connected to the base station device from among the plurality of processing devices based on the acquired information regarding the processing capabilities.

### BRIEF DESCRIPTION OF DRAWINGS

FIG. 1 is a diagram illustrating an example of connection on the Internet.

FIG. 2 is a diagram illustrating a configuration example of a 5G core network.

FIG. 3 is a diagram illustrating a configuration example of a 5G core network having an edge computing function.

FIG. 4 is a block diagram illustrating a configuration example of mobile edge computing (MEC).

FIG. 5 is a diagram for describing an outline of a technology common to embodiments of the present disclosure.

FIG. 6 is a diagram illustrating a configuration example of a communication system according to a first embodiment of the present disclosure.

FIG. 7 is a block diagram illustrating a configuration example of an authentication device according to the first embodiment of the present disclosure.

FIG. 8 is a block diagram illustrating a configuration example of a management device according to the first embodiment of the present disclosure.

FIG. 9 is a diagram illustrating an example of a processing capability database (DB) according to the first embodiment of the present disclosure.

FIG. 10 is a diagram illustrating another example of the processing capability DB according to the first embodiment of the present disclosure.

FIG. 11 is a diagram illustrating another example of the processing capability DB according to the first embodiment of the present disclosure.

FIG. 12 is a diagram illustrating another example of the processing capability DB according to the first embodiment of the present disclosure.

FIG. 13 is a diagram illustrating another example of the processing capability DB according to the first embodiment of the present disclosure.

FIG. 14 is a block diagram illustrating a configuration example of a control device according to the first embodiment of the present disclosure.

FIG. 15 is a block diagram illustrating a configuration example of a cloud server according to the first embodiment of the present disclosure.

FIG. 16 is a block diagram illustrating a configuration example of a base station device according to the first embodiment of the present disclosure.

FIG. 17 is a block diagram illustrating a configuration example of a mobile device according to the first embodiment of the present disclosure.

FIG. 18 is a sequence diagram illustrating an example of a signaling flow of the communication system according to the first embodiment of the present disclosure.

FIG. 19 is a diagram illustrating a configuration example of a communication system according to a second embodiment of the present disclosure.

FIG. 20 is a block diagram illustrating a configuration example of a second control device according to the second embodiment of the present disclosure.

FIG. 21 is a sequence diagram illustrating an example of a signaling flow of the communication system according to the second embodiment of the present disclosure.

FIG. 22 is a sequence diagram illustrating an example of a signaling flow of a communication system according to a first modified example of the present disclosure.

### DESCRIPTION OF EMBODIMENTS

Hereinafter, embodiments of the present disclosure will be described in detail with reference to the drawings. Note that, in each of the following embodiments, the same reference signs denote the same portions, and an overlapping description will be omitted.

Further, in the present specification and the drawings, a plurality of components having substantially the same functional configuration may be distinguished by adding different numbers or alphabets after the same reference signs. For example, a plurality of components having substantially the same functional configuration are distinguished as necessary, such as a cloud server 240A₁ and a cloud server 240A₂. However, in a case where it is not particularly necessary to distinguish each of the plurality of components having substantially the same functional configuration, only the same reference sign is given. For example, in a case where it is not particularly necessary to distinguish the cloud servers 240A₁ and 240A₂, they are simply referred to as a cloud server 240 or a cloud server 240A.

Further, the present disclosure will be described in the following order.

1. Introduction

2. Technology Common to Embodiments

3. First Embodiment

3.1. Configuration Example of Communication System

3.1.1. Configuration Example of Authentication Device

3.1.2. Configuration Example of Management Device

3.1.3. Configuration Example of Control Device

3.1.4. Configuration Example of Cloud Server

3.1.5. Configuration Example of Base Station Device

3.1.6. Configuration Example of UE

3.2. Virtual Core Network Construction Processing

4. Second Embodiment

4.1. Configuration Example of Communication System

4.2. Virtual Core Network Construction Processing

5. Modified Example

5.1. First Modified Example

5.2. Other Modified Examples

6. Conclusion

### 1. Introduction

(Internet Connection Example)

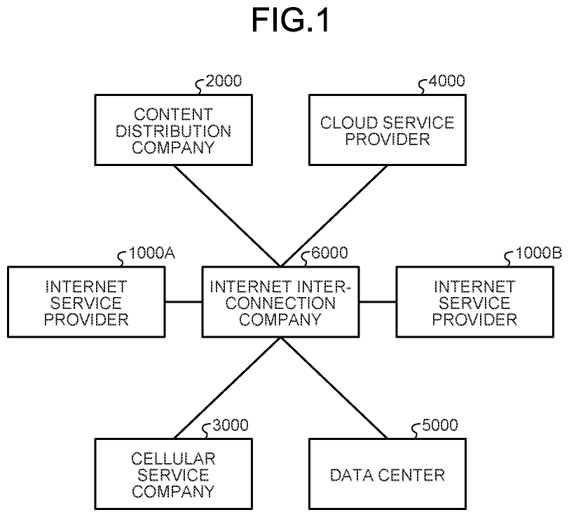

First, connection on the Internet will be described. FIG. 1 is a diagram illustrating an example of connection on the Internet. The Internet is not managed by a specific organization or business entity, but is configured by connecting a plurality of networks (Internet lines) managed and operated by respective organizations or business entities to each other by an Internet interconnection company 6000. Examples of an organization or a company that manages and operates a network include an Internet service provider (ISP) 1000, a content distribution company 2000, a cellular service company 3000, a cloud service provider 4000, a data center 5000, and the like as illustrated in FIG. 1.

The Internet service provider 1000 is a company that provides Internet connection for individual users or corporate users. Although two Internet service providers 1000A and 1000B are connected to the Internet in the example of FIG. 1, many Internet service providers are actually connected to the Internet.

The content distribution company 2000 is a company that provides web contents and online services. The content distribution company 2000 also includes a company that owns a network and secures Internet connection for contents.

The cellular service company 3000 is a company that provides a cellular service. In the technology of the present disclosure, for example, the cellular service company 3000 constructs a virtual core network in its own network and provides a cellular communication service to a company via the Internet. Thus, the cellular service company 3000 can construct the core network at low cost. In addition, it is possible to promote the appearance of not only a communication company having a large business scale but also a new company that provides a smaller scale network service.

The cloud service provider 4000 and the data center 5000 in FIG. 1 are companies that provide infrastructure resources for individual users or corporate users and provide Internet connection for customer contents. In this manner, a service for providing a cloud environment for individual users or corporate users is also referred to as an open cloud service.

The Internet interconnection company 6000 is a company that provides a service for interconnection between networks managed and operated by respective organizations or companies described above. As the Internet interconnection company 6000 interconnects the respective networks, the user enjoys various services on the Internet.

Here, the above-described companies such as the Internet service provider 1000, the content distribution company 2000, the cellular service company 3000, and the cloud service provider 4000 can each manage performance and quality in the network thereof. However, it is not necessarily easy to ensure the performance and quality of a network configured across a plurality of networks, such as a network configured by the cellular service company 3000 and the cloud service provider 4000. For example, it is difficult to ensure a latency characteristic in the network configured across the plurality of networks.

Note that the Internet connection example illustrated in FIG. 1 is only an example, and the types and the number of connected organizations or companies, a connection relationship, and the like are not limited to the example illustrated in FIG. 1. For example, a company or the like other than the above-described organizations or companies may be connected to the Internet. Alternatively, a plurality of companies that provide the same service may be connected. Furthermore, there may be a plurality of Internet interconnection companies 6000, each of which may connect the respective organizations, companies, or the like.

(Configuration Example of 5th Generation Mobile Communication System (5G) Core Network)

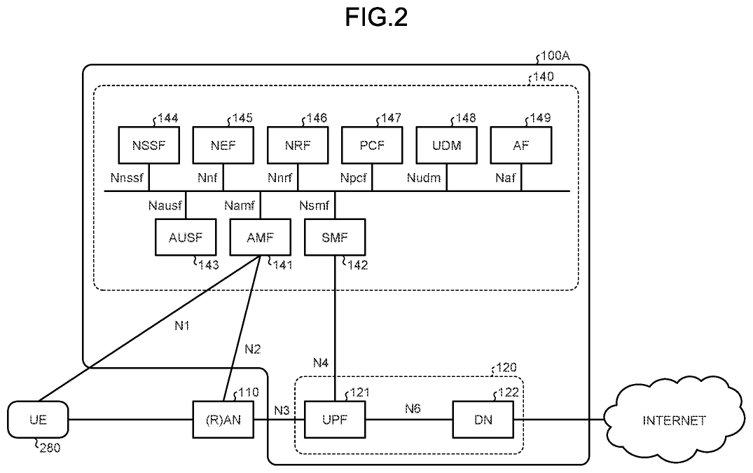

Next, a 5G core network will be described. FIG. 2 is a diagram illustrating a configuration example of a 5G core network 100A. The 5G core network 100A is also referred to as 5G core/next generation core (5GC/NGC). Hereinafter, the 5G core network 100A is also referred to as the 5GC/NGC 100A. The 5GC/NGC 100A is connected to a user equipment (UE) 280 via a (radio) access network ((R)AN) 110.

The (R)AN 110 has a function of enabling connection to a radio access network (RAN) and connection to an access network (AN) other than the RAN. The (R)AN 110 includes a base station device called a gNB or an ng-eNB.

The 5GC/NGC 100A includes a user plane function group 120 and a control plane function group 140.

The user plane function group 120 includes a user plane function (UPF) 121 and a data network (DN) 122. The UPF 121 has a user plane processing function. The UPF 121 has a function of routing/forwarding data handled in user plane. The DN 122 has a function of enabling connection to a unique service of the cellular service company 3000, the Internet, or a service of a third party.

The control plane function group 140 includes an access management function (AMF) 141, a session management function (SMF) 142, an authentication server function (AUSF) 143, a network slice selection function (NSSF) 144, a network exposure function (NEF) 145, a network repository function (NRF) 146, a policy control function (PCF) 147, a unified data management (UDM) 148, and an application function (AF) 149.

The AMF 141 has functions such as registration processing, connection management, and mobility management for the UE 280. The SMF 142 has functions such as session management and IP assignment and management for an UE 208. The AUSF 143 has an authentication function. The NSSF 144 has a function related to selection of a network slice. The NEF 145 has a function of providing network function capabilities and events to a third party, the AF 149, and an edge computing function.

The NRF 146 has a function of finding a network function and holding a profile of the network function. The PCF 147 has a policy control function. The UDM 148 has functions of generating 3GPP AKA authentication information and processing a user ID. The AF 149 has a function of interacting with the core network to provide a service.

(5G Core Network Having Edge Computing Function)

Here, the number of applications in which a processing device (for example, a cloud server) on the network and the UE 280 perform processing in cooperation with each other is increasing. In a case where the cloud server performs a part of the processing of the application, since the UE 280 and the cloud server need to exchange information on the network, processing latency inevitably occurs. However, high processing latency is not allowed in some applications. In recent years, edge computing that causes a cloud server at a position close to a device that executes an application to perform processing has begun to be known as a technology for implementing low-latency processing.

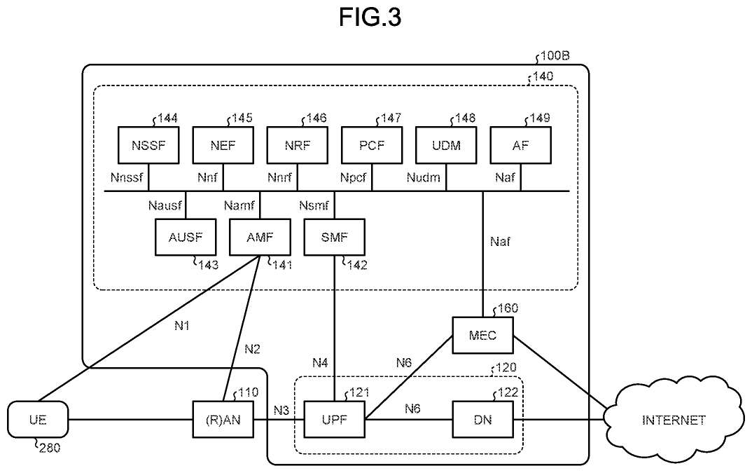

The 5G core network having such an edge computing function will be described. FIG. 3 is a diagram illustrating a configuration example of a 5G core network 100B having the edge computing function.

The 5GC/NGC 100B illustrated in FIG. 3 includes mobile edge computing (MEC) 160 in addition to the user plane function group 120 and the control plane function group 140. The MEC 160 may be regarded, from a control plane perspective, as a type of AF 149 that has a function of interacting with the core network to provide a service. In addition, the MEC 160 can be regarded, from a user plane perspective, as a type of DN 122 which is a function of providing various services. Therefore, as illustrated in FIG. 3, the MEC 160 is connected to the control plane function group 140 via an Naf interface, and is connected to the user plane function group via an N6 interface.

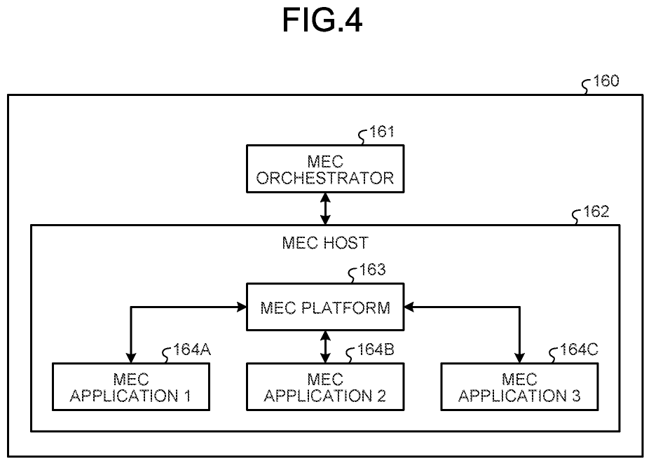

FIG. 4 is a block diagram illustrating a configuration example of the MEC 160. According to European telecommunications standards institute (ETSI) White Paper No. 28 entitled “MEC in 5G networks” issued by the ETSI, the MEC 160 has two major functions: an MEC orchestrator 161 and an MEC host 162.

The MEC orchestrator 161 is a control unit that performs a system-level control of the MEC 160. In addition, the MEC host 162 includes an MEC platform 163 and a plurality of MEC applications 164A to 164C. The MEC platform 163 has a function of controlling an access network, and controls the MEC applications 164.

Note that, as described in each embodiment below, in a case where the function of the UPF 121 is virtually implemented in the cloud server, the function of the UPF 121 can be implemented in the MEC 160. In other words, the MEC 160 may be connected to the (R)AN 110 via an N3 interface. The MEC 160 may also be connected to the SMF 142 via an Nsmf interface.

In addition, the function of the SMF 142 may be implemented in the MEC 160. In other words, the MEC 160 may be connected to other control plane function groups via the Nsmf interface, and the function of the SMF 142 and the function of the UPF 121 may be connected in the MEC 160 via an N4 interface.

Similarly, the function of the AMF 141 may be implemented in the MEC 160. In other words, the MEC 160 may be connected to the (R)AN 110 via an N2 interface. In addition, the MEC 160 may be connected to the UE via an N1 interface. The MEC 160 may be connected to other control plane function groups via an Namf interface.

Note that the number of the MEC applications 164 is not limited to three, and may be two or less, or may be four or more. In addition, the number of the MEC applications 164 may be dynamically changed by using a virtualization technology, or a server that provides the MEC application 164 may be changed according to mobility of the UE 280 serving as a client.

### 2. Technology Common to Embodiments

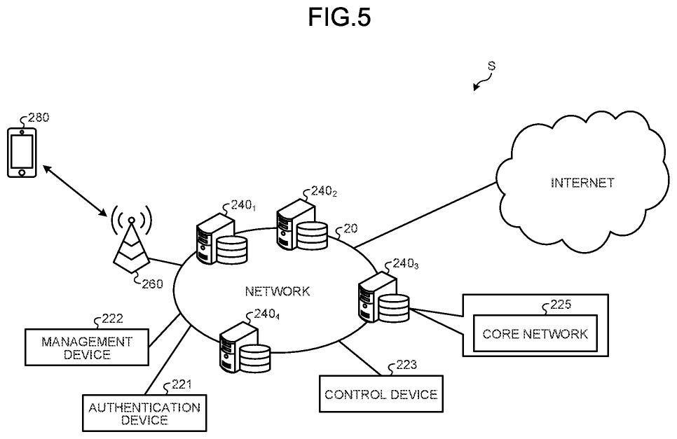

Next, an outline of a technology common to the embodiments of the present disclosure will be described with reference to FIG. 5. FIG. 5 is a diagram for describing the outline of the technology common to the embodiments of the present disclosure. In the technology of the present disclosure, at least one network function of a virtual core network 225 (corresponding to the above-described 5GC/NGC 100) is constructed on a network 20.

First, an example of a communication system S that implements the technology of the present disclosure will be described with reference to FIG. 5. The communication system S includes an authentication device 221, a management device 222, a control device 223, a plurality of cloud servers 2401 to 2404, a base station device 260, and the UE 280. The respective devices are connected to each other via the network 20.

As illustrated in FIG. 5, the network 20 is connected to the Internet. The network 20 may be one network (for example, an Internet line) operated by a certain network operator or may include a plurality of networks operated by different network operators. For example, the cloud servers 2401 and 2402 and the base station device 260 may be connected to one network, and the authentication device 221, the management device 222, the control device 223, and the cloud servers 2403 and 2404 may be connected to another network.

In such a communication system S, the control device 223 constructs the virtual core network 225 connected to the base station device 260 in the cloud server 240. At this time, for example, in a case where the control device 223 selects the cloud server 240 in which the virtual core network 225 is to be constructed for a reason that the corresponding cloud server 240 is geographically close to the base station device 260, the cloud server 2401 is selected as a server in which the virtual core network 225 is to be constructed. However, from the viewpoint of signal latency between the base station device 260 and the cloud server 240, latency between the base station device 260 and the cloud server 2401 that is geographically closest is not necessarily the lowest. For example, in a case where latency between the cloud server 2404 and the base station device 260 is the lowest, it is possible to provide a cellular service with lower latency by constructing the virtual core network 225 in the cloud server 2403.

Therefore, in the technology of the present disclosure, the control device 223 selects the cloud server 240 (an example of a processing device) in which at least one network function of the virtual core network 225 is to be implemented based on information regarding a processing quality of the cloud server 240. The control device 223 constructs at least one network function of the virtual core network 225 in the selected cloud server 240.

Here, examples of the information regarding the processing quality of the cloud server 240 include information regarding latency between the base station device 260 and the cloud server 240. In this case, for example, the control device 223 selects, as the processing device in which the virtual core network 225 is to be constructed, the cloud server 240 (the cloud server 2403 in FIG. 5) with the lowest latency with respect to the base station device 260.

In addition, the examples of the information regarding the processing quality of the cloud server 240 also include information regarding a processing capability of the cloud server 240. In this case, for example, the control device 223 selects, as the processing device in which the virtual core network 225 is to be constructed, the cloud server 240 (the cloud server 2403 in FIG. 5) having the highest processing capability. Note that the control device 223 may select the cloud server 240 based on a dynamic processing capability.

As a result, latency between the base station device 260 and the virtual core network 225 can be decreased, and the virtual core network 225 with lower latency can be constructed.

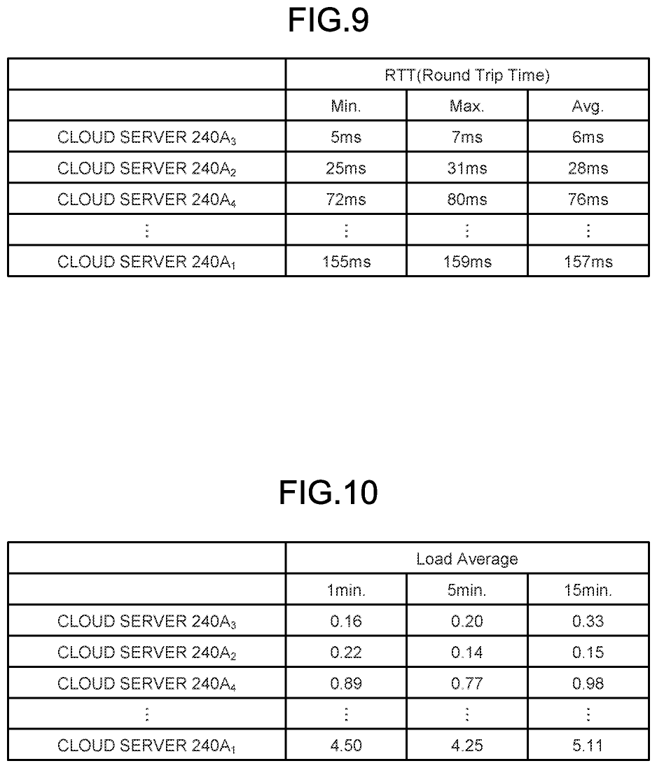

Note that, in the communication system S described above, the number of cloud servers 240 is four, but is not limited thereto. The number of cloud servers 240 may be three or less or five or more. Furthermore, details of the information regarding the processing capability described above will be described later with reference to FIGS. 9 to 13.

### 3. First Embodiment

Next, a first embodiment of the present disclosure will be described. In the present embodiment, a case where a network to which a base station device 260 is connected is different from a network to which a control device 223 is connected, and the control device 223 constructs a virtual core network 225 in the network to which the control device 223 is connected will be described.

### 3.1. Configuration Example of Communication System

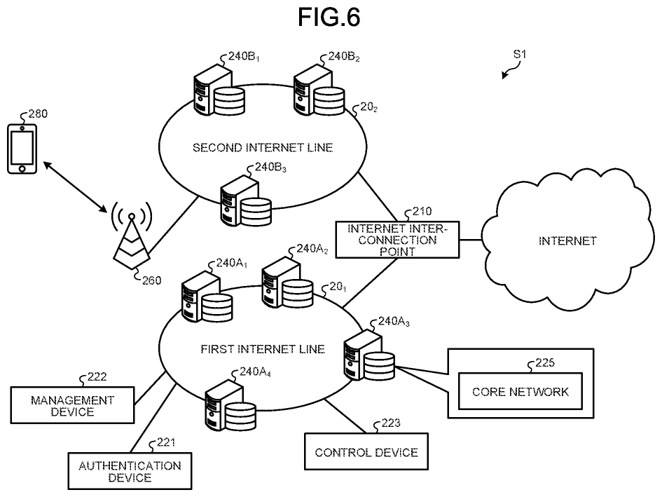

FIG. 6 is a diagram illustrating a configuration example of a communication system S1 according to the first embodiment of the present disclosure. The communication system S1 includes an authentication device 221, a management device 222, the control device 223, cloud servers 240, and the base station device 260.

The authentication device 221, the management device 222, the control device 223, and cloud servers 240A₁ to 240A₄ are connected to a predetermined network (a first Internet line 20₁ in the example of FIG. 6). Further, the base station device 260 and cloud servers 240B₁ to 240B₃ are connected to a network different from the first Internet line 20₁ (a second Internet line 20₂ in the example of FIG. 6). The first and second Internet lines 20₁ and 20₂ are connected at an Internet interconnection point 210. The first and second Internet lines 20₁ and 20₂ are also connected to other networks, for example, the Internet, at the Internet interconnection point 210.

Here, it is assumed that a company that operates and manages the virtual core network 225 (hereinafter, also referred to as a core network operator) has a contract for using the first Internet line 20₁. Alternatively, the core network operator may operate and manage the first Internet line 20₁.

In addition, an entity that installs, operates, and manages the base station device 260 is assumed to be a company different from the core network operator. Here, a company that installs, operates, and the like the base station device 260 is referred to as a base station operator. For example, in a case where a facility in which the base station device 260 is installed (for example, a retail store or an individual home) is managed by a general user or the like, the base station operator is the general user unlike the core network operator. In this case, the Internet line contracted and used by the base station operator is not necessarily the first Internet line 20₁, and may be the second Internet line 20₂ different from the first Internet line 20₁ as illustrated in FIG. 6.

Here, the base station operator is different from the core network operator, but the base station operator may be the same as the core network operator. In addition, a company that installs the base station device 260 and a company that operates, manages, and the like the base station device 260 may be different from each other.

Here, the second Internet line 20₂ used by the base station operator is different from the first Internet line 20₁ used by the core network operator, but the present disclosure is not limited thereto. For example, in a case where the base station operator has a contract for using the first Internet line 20₁, the Internet line used by the base station operator and the Internet line used by the core network operator are the same. Also in a case where the base station operator and the core network operator are the same, the Internet line used by the base station operator and the Internet line used by the core network operator can be the same.

The core network operator constructs the virtual core network 225 in the cloud server 240A₃ in the first Internet line 20₁ by using virtualization to provide a local cellular network (for example, local 5G) by the base station device 260. Note that a method of selecting the cloud server 240A in which the virtual core network 225 is to be constructed will be described later. Here, the local cellular network can broadly include a form called a private network, a non-public network, or the like.

Note that FIG. 6 illustrates an example in which the virtual core network 225 is constructed in the cloud server 240A₃, but the present disclosure is not limited thereto. The core network operator only needs to select the cloud server 240 in which the virtual core network 225 is to be constructed by executing a method using the control device 223 as described later, for example, and may construct the virtual core network 225 in the cloud server 240A other than the cloud server 240A₃.

Alternatively, although the virtual core network 225 includes a plurality of network functions, the core network operator may construct the respective network functions in different cloud servers 240A in a distributed manner by virtualization. Furthermore, the core network operator may construct the same network function in such a manner as to distribute the same network function to a plurality of different cloud servers 240A for each network slice provided in accordance with different wireless communication requests. Note that it is assumed that the core network operator constructs the virtual core network 225 in the cloud server 240A₃ by using the control device 223, for example.

Note that, in FIG. 6, the number of cloud servers 240A is four, and the number of cloud servers 240B is three. However, the number of cloud servers 240 is not limited thereto, and may be two or less or five or more.

Note that the devices in the drawing may be considered as devices in a logical sense. That is, some devices in the drawing may be implemented by a virtual machine (VM), a container, a docker, or the like, and may be implemented on the physically same hardware.

### 3.1.1. Configuration Example of Authentication Device

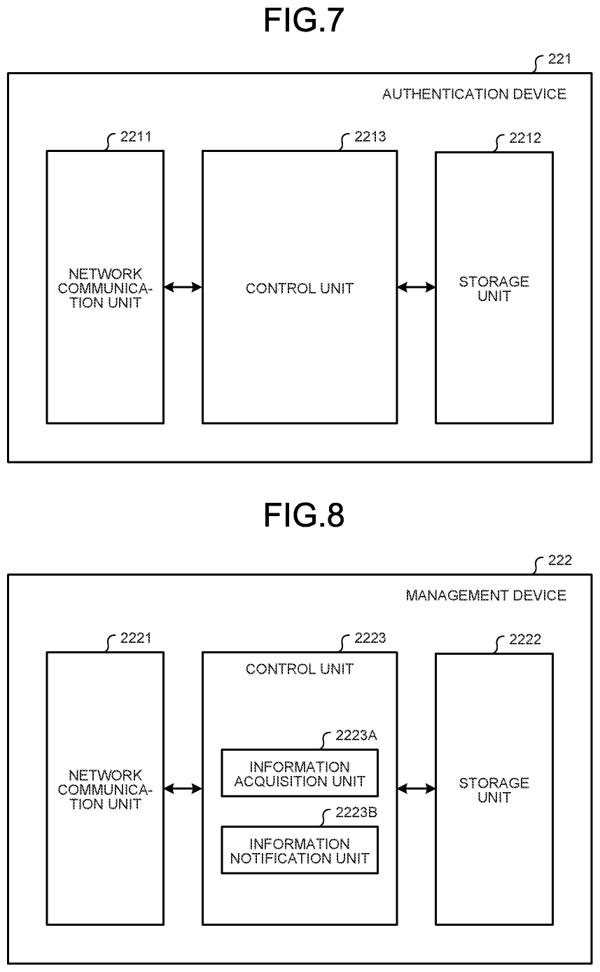

FIG. 7 is a block diagram illustrating a configuration example of the authentication device 221 according to the first embodiment of the present disclosure. The authentication device 221 performs authentication to check, for example, whether or not the control device 223 used by the core network operator can be connected to the first Internet line 20₁.

The authentication device 221 includes a network communication unit 2211, a storage unit 2212, and a control unit 2213. Note that the configuration illustrated in FIG. 7 is a functional configuration, and a hardware configuration may be different from this. Further, the functions of the authentication device 221 may be distributed to and implemented in a plurality of physically separated components. For example, the authentication device 221 may be implemented by a plurality of server devices. Further, the functions of the authentication device 221 may be dynamically distributed to and implemented in a plurality of physically separated components.

The network communication unit 2211 is a communication interface for performing communication with another device. The network communication unit 2211 may be a network interface or may be a device connection interface. The network communication unit 2211 has a function of establishing direct or indirect connection to the first Internet line 20₁. For example, the network communication unit 2211 may include a local area network (LAN) interface such as a network interface card (NIC), or may include a universal serial bus (USB) interface implemented by a USB host controller, a USB port, and the like. Further, the network communication unit 2211 may be a wired interface or a wireless interface. The network communication unit 2211 functions as communication means of the authentication device 221. The network communication unit 2211 performs communication with the control device 223 under the control of the control unit 2213.

The storage unit 2212 is a data readable/writable storage device such as a dynamic random access memory (DRAM), a static random access memory (SRAM), a flash memory, or a hard disk. The storage unit 2212 functions as storage means of the authentication device 221.

The control unit 2213 is a controller that controls each unit of the authentication device 221. The control unit 2213 is implemented by, for example, a processor such as a central processing unit (CPU) or a micro processing unit (MPU). For example, the control unit 2213 is implemented in a manner in which the processor executes various programs stored in the storage device inside the authentication device 221 by using a random access memory (RAM) or the like as a work area. Note that the control unit 2213 may be implemented by an integrated circuit such as an application specific integrated circuit (ASIC) or a field programmable gate array (FPGA). The CPU, the MPU, the ASIC, and the FPGA can all be regarded as the controller.

Note that each function of the authentication device 221 may be implemented as a function of the AUSF 143 in the 5GC/NGC 100 illustrated in FIGS. 2 and 3. In addition, the storage unit 2212 of the authentication device 221 may be implemented as the UDM 148 which is a network function of holding, managing, and processing subscriber information in the 5GC/NGC 100 illustrated in FIGS. 2 and 3.

### 3.1.2. Configuration Example of Management Device

FIG. 8 is a block diagram illustrating a configuration example of the management device 222 according to the first embodiment of the present disclosure. The management device 222 illustrated in FIG. 8 acquires and manages information regarding a processing capability of the cloud server 240A in the first Internet line 20₁. In addition, the management device 222 acquires and manages information regarding the cloud server 240A, for example, information for another device to access the cloud server 240A, such as an IP address or a port number.

The management device 222 includes a network communication unit 2221, a storage unit 2222, and a control unit 2223. Note that the configuration illustrated in FIG. 8 is a functional configuration, and a hardware configuration may be different from this. Further, the functions of the management device 222 may be distributed to and implemented in a plurality of physically separated components. For example, the management device 222 may be implemented by a plurality of server devices. Further, the functions of the management device 222 may be dynamically distributed to and implemented in a plurality of physically separated components.

The network communication unit 2221 is a communication interface for performing communication with another device. Note that a configuration of the network communication unit 2211 may be similar to the configuration of the network communication unit 2211 of the authentication device 221. The network communication unit 2221 functions as communication means of the management device 222. The network communication unit 2221 performs communication with the control device 223 and the cloud server 240A under the control of the control unit 2223.

The storage unit 2222 is a data readable/writable storage device such as a DRAM, an SRAM, a flash memory, or a hard disk. The storage unit 2222 functions as storage means of the management device 222. The storage unit 2222 includes a processing quality DB 2222A that stores information regarding a processing quality of the cloud server 240A acquired by the control unit 2223 to be described later.

FIG. 9 is a diagram illustrating an example of the processing quality DB 2222A according to the first embodiment of the present disclosure. The processing quality DB 2222A stores a latency characteristic (also simply referred to as latency) between the Internet interconnection point and the cloud server 240A as the information regarding the processing quality acquired by the control unit 2223. Specifically, the processing quality DB 2222A stores, as the latency characteristic, round-trip time (RTT) measured by the cloud server 240A.

The processing quality DB 2222A stores a minimum value (Min.), a maximum value (Max.), and an average value (Avg.) of the RRT of the cloud server 240A for each cloud server 240A. In the example of FIG. 9, the RRT of the cloud server 240A₃ has a minimum value of 5 ms, a maximum value of 7 ms, and an average value of 6 ms, which is the shortest among all the cloud servers 240A.

Note that the information regarding the processing quality stored in the processing quality DB 2222A is not limited to the information regarding the latency characteristic. For example, the processing quality DB 2222A may store, as the information regarding the processing quality, information regarding dynamic processing capabilities, for example, a processing speed and an available capacity. The control unit 2223 also acquires the information regarding the dynamic processing capabilities and stores the information in the processing quality DB 2222A.

FIG. 10 is a diagram illustrating another example of the processing quality DB 2222A according to the first embodiment of the present disclosure. The processing quality DB 2222A illustrated in FIG. 10 stores, as the information regarding the processing quality, information regarding the processing speed of the cloud server 240A.

The processing quality DB 2222A illustrated in FIG. 10 stores, for example, a load average as the processing speed of the cloud server 240. The load average is an average value of the number of processes waiting for execution, and the cloud server 240A having a smaller load average is evaluated as having a higher processing speed. The cloud server 240A outputs a load average for each of the past one minute, the past five minutes, and the past 15 minutes as an output value for a top command or an uptime command, for example. The processing quality DB 2222A stores the load average for each of the past one minute, the past five minutes, and the past 15 minutes output from the cloud server 240A in association with each cloud server 240A.

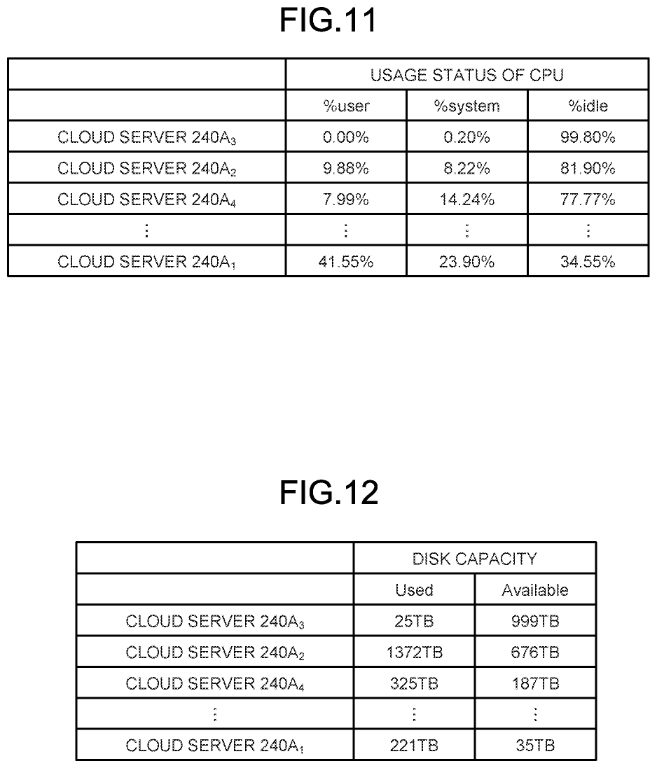

FIG. 11 is a diagram illustrating another example of the processing quality DB 2222A according to the first embodiment of the present disclosure. The processing quality DB 2222A illustrated in FIG. 11 stores, for example, a usage status of the CPU, as the processing speed of the cloud server 240A. The cloud server 240A outputs the usage status of the CPU, for example, as an output value for an sar command. The processing quality DB 2222A stores the usage status of the CPU output from the cloud server 240A in association with each cloud server 240A.

In the example of FIG. 11, the processing quality DB 2222A stores, for each cloud server 240A, % user indicating a ratio at which the CPU is used for a user process, % system indicating a ratio at which the CPU is used for kernel processing, and % idle indicating a ratio at which the CPU is in a standby state. The cloud server 240A having a lower % user or % system and a higher % idle is evaluated as being in a state in which the processing speed is high.

Note that the processing quality DB 2222A may store, as the information regarding the processing quality, information regarding a capacity of the cloud server 240A.

FIG. 12 is a diagram illustrating another example of the processing quality DB 2222A according to the first embodiment of the present disclosure. The processing quality DB 2222A illustrated in FIG. 12 stores, as the information regarding the processing quality, information regarding the capacity of the cloud server 240A.

The processing quality DB 2222A illustrated in FIG. 12 stores, for example, a disk capacity as the capacity of the cloud server 240A. The cloud server 240A outputs an available disk capacity as an output value for a df command, for example. The processing quality DB 2222A stores the disk capacity output from the cloud server 240A in association with each cloud server 240A.

In the example of FIG. 12, the processing quality DB 2222A stores, for each cloud server 240A, Used indicating a used disk capacity and Available indicating an available disk capacity. The cloud server 240A having a larger available disk capacity (Available) is evaluated as having a larger server capacity.

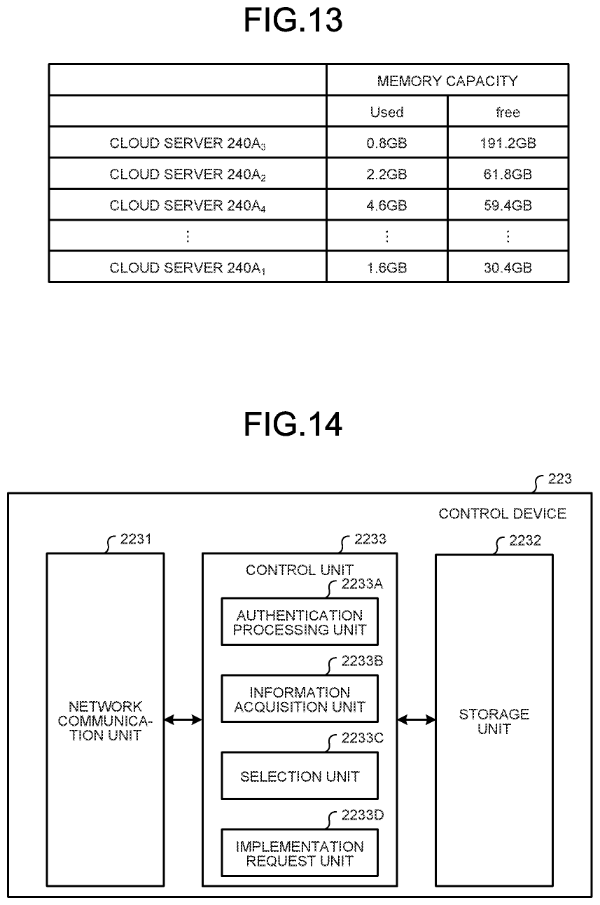

FIG. 13 is a diagram illustrating another example of the processing quality DB 2222A according to the first embodiment of the present disclosure. The processing quality DB 2222A illustrated in FIG. 13 stores, for example, a memory capacity as the capacity of the cloud server 240A. The cloud server 240A outputs an available memory capacity as an output value for a free command, for example. The processing quality DB 2222A stores the memory capacity output from the cloud server 240A in association with each cloud server 240A.

In the example of FIG. 13, the processing quality DB 2222A stores, for each cloud server 240A, Used indicating a used memory capacity and Available indicating an available memory capacity. The cloud server 240A having a larger available memory capacity (Available) is evaluated as having a larger server capacity.

The description returns to FIG. 8. The control unit 2223 is a controller that controls each unit of the management device 222. The control unit 2223 is implemented by, for example, a processor such as a CPU or an MPU. For example, the control unit 2223 is implemented in a manner in which the processor executes various programs stored in the storage device inside the management device 222 by using a RAM or the like as a work area. Note that the control unit 2223 may be implemented by an integrated circuit such as an ASIC or a FPGA. The CPU, the MPU, the ASIC, and the FPGA can all be regarded as the controller.

The control unit 2223 includes an information acquisition unit 2223A and an information notification unit 2223B. The respective blocks (the information acquisition unit 2223A and the information notification unit 2223B) included in the control unit 2223 are functional blocks indicating the functions of the control unit 2223. These functional blocks may be software blocks or hardware blocks. For example, each of the above-described functional blocks may be one software module implemented by software (including a microprogram) or may be one circuit block on a semiconductor chip (die). It is a matter of course that each functional block may be one processor or one integrated circuit. A method of configuring the functional block is arbitrary. Note that the control unit 2223 may be configured with a functional unit different from the above-described functional block.

The information acquisition unit 2223A acquires the information regarding the processing quality from the cloud server 240A. The information acquisition unit 2223A acquires, for example, the information regarding the latency characteristic as the processing quality of the cloud server 240A. For example, the information acquisition unit 2223A requests the cloud server 240A to measure latency between an arbitrary reference point and the cloud server 240A, and acquires a measurement result. Here, an arbitrary reference point (a predetermined position) for which the latency is measured in the first embodiment is the Internet interconnection point 210 illustrated in FIG. 6.

It is difficult for the cloud server 240A connected to the first Internet line 20₁ to acquire information regarding latency between the cloud server 240A and an arbitrary device connected to the second Internet line 20₂. Therefore, the information acquisition unit 2223A acquires, as latency between the base station device 260 and the cloud server 240A, the latency between the cloud server 240A and the Internet interconnection point 210 connecting the first Internet line 20₁ and the second Internet line 20₂.

In a case where latency from the base station device 260 to the Internet interconnection point 210 is the same for each cloud server 240A, the latency between the base station device 260 and the cloud server 240A is a time according to the latency between the Internet interconnection point 210 and the cloud server 240A. Therefore, the information acquisition unit 2223A can indirectly (relatively) detect the latency between the base station device 260 and the cloud server 240A by acquiring the latency between the Internet interconnection point 210 and the cloud server 240A. In this manner, the information acquisition unit 2223A acquires a relative relationship regarding the latency of the plurality of cloud servers 240A. The information acquisition unit 2223A manages the information regarding the processing quality by storing the acquired information regarding the processing quality in the processing quality DB 2222A illustrated in FIG. 9.

Note that the arbitrary reference point is not limited to the Internet interconnection point 210. The information acquisition unit 2223A may designate a host name or an IP address serving as a predetermined reference point for each cloud server 240A, thereby acquiring latency between the predetermined reference point and the cloud server 240A.

Furthermore, the information regarding the processing quality of the cloud server 240A acquired by the information acquisition unit 2223A is not limited to the latency characteristic. The information acquisition unit 2223A may acquire the information regarding the processing speed and capacity of the cloud server 240A as illustrated in FIGS. 10 to 13. Furthermore, the information acquisition unit 2223A may acquire a plurality of pieces of information such as the latency characteristic and the processing speed.

In response to a request from the control device 223, the information notification unit 2223B makes a notification of the information regarding the processing quality of the cloud server 240A, information for connection to the cloud server 240A, and the like.

Note that some functions of the management device 222 described above, for example, the function of managing and storing the information regarding the processing quality of the cloud server 240A (the function of the information acquisition unit 2223A) may be implemented as the function of the NRF 146 of the 5GC/NGC 100 illustrated in FIGS. 2 and 3. In addition, some functions of the management device 222, for example, the function of making a notification of the information regarding the processing quality of the cloud server 240A (the function of the information notification unit 2223B) may be implemented as the function of the AF 149 or the NEF 145 of the 5GC/NGC 100 illustrated in FIGS. 2 and 3.

### 3.1.3. Configuration Example of Control Device

FIG. 14 is a block diagram illustrating a configuration example of the control device 223 according to the first embodiment of the present disclosure. The control device 223 illustrated in FIG. 14 constructs the virtual core network 225 to which the base station device 260 is to be connected.

The control device 223 includes a network communication unit 2231, a storage unit 2232, and a control unit 2233. Note that the configuration illustrated in FIG. 14 is a functional configuration, and a hardware configuration may be different from this. Further, the functions of the control device 223 may be distributed to and implemented in a plurality of physically separated components. For example, the control device 223 may be implemented by a plurality of server devices. Further, the functions of the control device 223 may be dynamically distributed to and implemented in a plurality of physically separated components.

The network communication unit 2231 is a communication interface for performing communication with another device. Note that a configuration of the network communication unit 2231 may be similar to the configuration of the network communication unit 2211 of the authentication device 221 and the configuration of the network communication unit 2221 of the management device 222. The network communication unit 2231 functions as communication means of the control device 223. The network communication unit 2231 performs communication with the authentication device 221, the management device 222, and the cloud server 240A under the control of the control unit 2233.

The storage unit 2232 is a data readable/writable storage device such as a DRAM, an SRAM, a flash memory, or a hard disk. The storage unit 2232 functions as storage means of the control device 223.

The control unit 2233 is a controller that controls each unit of the control device 223. The control unit 2233 is implemented by, for example, a processor such as a CPU or an MPU. For example, the control unit 2233 is implemented in a manner in which the processor executes various programs stored in the storage device inside the control device 223 by using a RAM or the like as a work area. Note that the control unit 2233 may be implemented by an integrated circuit such as an ASIC or a FPGA. The CPU, the MPU, the ASIC, and the FPGA can all be regarded as the controller.

The control unit 2233 includes an authentication processing unit 2233A, an information acquisition unit 2233B, a selection unit 2233C, and an implementation request unit 2233D. The respective blocks (the authentication processing unit 2233A, the information acquisition unit 2233B, the selection unit 2233C, and the implementation request unit 2233D) included in the control unit 2233 are functional blocks indicating the functions of the control unit 2233. These functional blocks may be software blocks or hardware blocks. For example, each of the above-described functional blocks may be one software module implemented by software (including a microprogram) or may be one circuit block on a semiconductor chip (die). It is a matter of course that each functional block may be one processor or one integrated circuit. A method of configuring the functional block is arbitrary. Note that the control unit 2233 may be configured with a functional unit different from the above-described functional block.

The authentication processing unit 2233A performs authentication processing with the authentication device 221 in order to establish connection to the first Internet line 20₁. In a case where the authentication processing unit 2233A is successfully authenticated by the authentication device 221, the control device 223 is authenticated as a device that can be connected to the first Internet line 20₁, and can use the network function in the first Internet line 20₁.

The information acquisition unit 2233B acquires the information regarding the processing quality of the cloud server 240A from the management device 222 by using the first Internet line 20₁. The information acquisition unit 2233B acquires, for example, the information regarding the latency characteristic as the information regarding the processing quality. Alternatively, the information acquisition unit 2233B may acquire the information regarding the processing speed or the capacity as the information regarding the processing quality. The information acquisition unit 2233B acquires one or more pieces of information regarding the processing quality. In addition, the information acquisition unit 2233B acquires information (for example, an IP address or a port number) for accessing the cloud server 240A from the management device 222.

The selection unit 2233C selects the cloud server 240A (hereinafter, also referred to as a construction server) in which the virtual core network 225 is to be constructed based on the information regarding the processing quality of the cloud server 240A acquired by the information acquisition unit 2233B.

For example, in a case where the construction server is selected based on the latency characteristic, the selection unit 2233C selects the cloud server 240A with the lowest latency with respect to the Internet interconnection point 210, instead of the cloud server 240A geographically closest to the base station device 260. In the example illustrated in FIG. 9, the selection unit 2233C selects the cloud server 240A₃ as the construction server that executes at least some functions of the virtual core network 225.

Alternatively, the selection unit 2233C may select the construction server based on the processing speed. In this case, the selection unit 2233C selects, for example, the cloud server 240A (the cloud server 240A₃ in the examples of FIGS. 10 and 11) having the highest processing speed within an allowable latency range as the construction server.

Furthermore, the selection unit 2233C may select the construction server based on the capacity. In this case, the selection unit 2233C selects, for example, the cloud server 240A (the cloud server 240A₃ in the examples of FIGS. 12 and 13) having the largest capacity within the allowable latency range as the construction server.

The implementation request unit 2233D requests the cloud server 240A₃ selected by the selection unit 2233C to implement some or all of the functions of the virtual core network 225. In a case where the cloud server 240A₃ is requested to implement some functions, for example, the selection unit 2233C may select a function to be implemented according to the processing quality of the cloud server 240A.

Note that some of the functions of the control unit 2233, for example, the function of the information acquisition unit 2233B and the function of the selection unit 2233C may be implemented as the functions of the AF 149 illustrated in FIGS. 2 and 3. In addition, some of the functions of the control unit 2233, for example, the function of the implementation request unit 2233D may also be implemented as the function of the AF 149 illustrated in FIGS. 2 and 3.

### 3.1.4. Configuration Example of Cloud Server

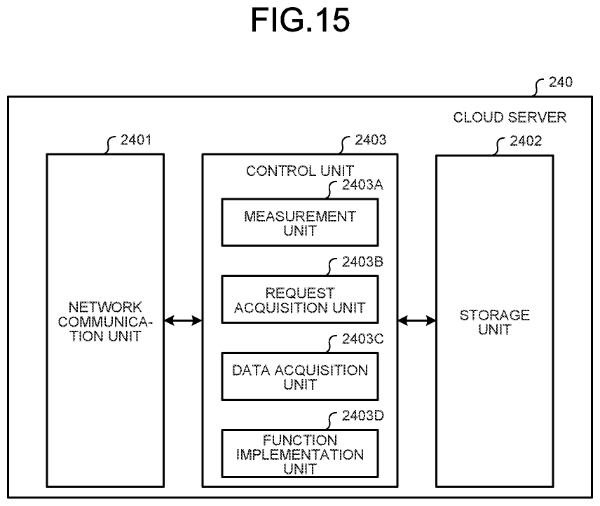

FIG. 15 is a block diagram illustrating a configuration example of the cloud server 240A according to the first embodiment of the present disclosure. The cloud server 240A is a processing device connected to the first Internet line 20₁. For example, the cloud server 240A is a server host computer that processes a request from a client computer (for example, the control device 223). The cloud server 240A may be a personal computer (PC) server, a midrange server, or a mainframe server. The cloud server 240A can be rephrased as a server device or a processing device (or information processing device).

The cloud server 240A includes a network communication unit 2401, a storage unit 2402, and a control unit 2403. Note that the configuration illustrated in FIG. 15 is a functional configuration, and a hardware configuration may be different from this. Further, the functions of the cloud server 240A may be distributed to and implemented in a plurality of physically separated components. For example, the cloud server 240A may be implemented by a plurality of server devices. Further, the functions of the cloud server 240A may be dynamically distributed to and implemented in a plurality of physically separated components.

The network communication unit 2401 is a communication interface for performing communication with another device. Note that a configuration of the network communication unit 2401 may be similar to the configuration of the network communication unit 2211 of the authentication device 221 and the configuration of the network communication unit 2221 of the management device 222. The network communication unit 2401 functions as communication means of the cloud server 240A. The network communication unit 2401 performs communication with the management device 222 and the control device 223 under the control of the control unit 2403.

The storage unit 2402 is a data readable/writable storage device such as a DRAM, an SRAM, a flash memory, or a hard disk. The storage unit 2402 functions as storage means of the cloud server 240A.

The control unit 2403 is a controller that controls each unit of the cloud server 240A. The control unit 2403 is implemented by, for example, a processor such as a CPU or an MPU. For example, the control unit 2403 is implemented in a manner in which the processor executes various programs stored in the storage device inside the cloud server 240A by using a RAM or the like as a work area. Note that the control unit 2403 may be implemented by an integrated circuit such as an ASIC or a FPGA. The CPU, the MPU, the ASIC, and the FPGA can all be regarded as the controller.

The control unit 2403 includes a measurement unit 2403A, a request acquisition unit 2403B, a data acquisition unit 2403C, and a function implementation unit 2403D. The respective blocks (the measurement unit 2403A, the request acquisition unit 2403B, the data acquisition unit 2403C, and the function implementation unit 2403D) included in the control unit 2403 are functional blocks indicating the functions of the control unit 2403. These functional blocks may be software blocks or hardware blocks. For example, each of the above-described functional blocks may be one software module implemented by software (including a microprogram) or may be one circuit block on a semiconductor chip (die). It is a matter of course that each functional block may be one processor or one integrated circuit. A method of configuring the functional block is arbitrary. Note that the control unit 2403 may be configured with a functional unit different from the above-described functional block.

In response to a request from the management device 222, the measurement unit 2403A measures latency between the cloud server 240A and an arbitrary reference point, here, the Internet interconnection point 210, and notifies the management device 222 of the measurement result. The request acquisition unit 2403B acquires an implementation request for the virtual core network 225 from the control device 223.

When the request acquisition unit 2403B acquires the implementation request for the virtual core network 225, the data acquisition unit 2403C acquires information necessary for implementation of the virtual core network 225 from the control device 223, for example. The data acquisition unit 2403C downloads software, data, a setting file, and the like necessary for implementation of the virtual core network 225 from the control device 223, for example. Note that the data acquisition unit 2403C may download information necessary for implementation of the virtual core network 225 from a device other than the control device 223. For example, the control device 223 may notify the data acquisition unit 2403C of a host name or an IP address of a device to which the information necessary for implementation of the virtual core network 225 is to be downloaded.

The function implementation unit 2403D implements (constructs) some or all of the network functions of the cloud-based virtual core network 225 by using the data downloaded by the data acquisition unit 2403C. Note that the setting file acquired by the data acquisition unit 2403C includes information for setting at least one or more subnets. In addition, the function implementation unit 2403D may set one or more subnets in the virtual core network 225 to be constructed, or may set one subnet for each network function to be constructed.

In accordance with an instruction from the control device 223, the function implementation unit 2403D implements the functions of the UPF 121 and the MEC 160 in the 5GC/NGC 100B illustrated in FIG. 3, for example, as some of the network functions of the cloud-based virtual core network 225. As a result, the UE 280 that receives a cellular service provided by the virtual core network 225 via the base station device 260 can transmit and receive data in a low-latency environment when transmitting and receiving the data processed by the MEC 160 via the UPF 121.

In addition, some network functions of the cloud-based virtual core network 225 implemented by the function implementation unit 2403D may be, for example, the AMF 141 and the SMF 142 in the 5GC/NGC 100 illustrated in FIGS. 2 and 3. As a result, the UE 280 can transmit and receive control information in a low-latency environment when exchanging the control information processed by the AMF 141. For example, examples of the control information transmitted to and received from the AMF 141 include information regarding beamforming in a millimeter wave band. Since the control information regarding the beamforming in the millimeter wave band can be transmitted and received with low latency, a response in beam management according to mobility can be improved. By utilizing the beamforming in the millimeter wave band, a high data rate can be realized, and communication quality can be improved.

### 3.1.5. Configuration Example of Base Station Device

The base station device 260 is a wireless communication device that performs wireless communication with the UE 280. The base station device 260 is a type of communication device. The base station device 260 is, for example, a device corresponding to a wireless base station (Node B, eNB, gNB, ng-eNB, or the like) or a radio access point. The base station device 260 may be a wireless relay station or a donor node of integrated access and backhaul (IAB). The base station device 260 may be a road side base station device such as a road side unit (RSU). Furthermore, the base station device 260 may be an optical feeder device which is called a remote radio head (RRH). In the present embodiment, the base station of the wireless communication system may be referred to as the base station device. The base station device 260 may be configured to be able to perform wireless communication with another base station device 260.

Note that the concept of the base station device (also referred to as the base station) includes not only a donor base station but also a relay base station (also referred to as a relay station or a relay station device). Further, the concept of the base station includes not only a structure having the function of the base station, but also a device installed in the structure. The structure is, for example, a building such as a skyscraper, a house, a steel tower, a station facility, an airport facility, a port facility, or a stadium. Note that the concept of the structure includes not only a building, but also a non-building structure such as a tunnel, a bridge, a dam, a fence, or a steel column, or a facility such as a crane, a gate, or a windmill. In addition, the concept of the structure includes not only a structure on land (on the ground in a narrow sense) or in the ground, but also a structure on the water, such as a landing stage or Mega-Float, or a structure underwater such as an oceanographical observation facility. The base station device can be rephrased as a processing device (or information processing device).

The base station device 260 may be a fixed station or a base station device (mobile station) configured to be movable. For example, the base station device 260 may be a device installed on a mobile body, or may be the mobile body itself. For example, a relay station device having mobility can be regarded as the base station device 260 as the mobile station. In addition, a device that originally has mobility, such as a vehicle, a drone, or a smartphone, and has the function of the base station device (at least a part of the function of the base station device) also corresponds to the base station device 260 as the mobile station.

Here, the mobile body may be a mobile terminal such as a smartphone or a mobile phone. The mobile body may be a mobile body (for example, a vehicle such as an automobile, a bicycle, a bus, a truck, a motorcycle, a train, or a linear motor car) that moves on land (on the ground in a narrow sense), or may be a mobile body (for example, subway) that moves in the ground (for example, in a tunnel). Further, the mobile body may be a mobile body (for example, a vessel such as a passenger ship, a cargo ship, or a hovercraft) that moves on the water, or may be a mobile body (for example, a submersible boat such as a submersible, a submarine, or an unmanned underwater vehicle) that moves underwater. Further, the mobile body may be a mobile body (for example, an aircraft such as an airplane, an airship, or a drone) that moves in the atmosphere, or may be a mobile body (for example, an artificial celestial body such as a satellite, a spaceship, a space station, or a space probe) that moves outside the atmosphere.

Furthermore, the base station device 260 may be a ground base station device (ground station device) installed on the ground. For example, the base station device 260 may be a base station device arranged in a structure on the ground, or may be a base station device installed in a mobile body moving on the ground. More specifically, the base station device 260 may be an antenna installed in a structure such as a building and a signal processing device connected to the antenna. It is a matter of course that the base station device 260 may be a structure or a mobile body itself. The phrase “on the ground” not only means on land (on the ground in a narrow sense), but also means in the ground, on the water, and underwater in a broad sense. Note that the base station device 260 is not limited to the ground base station device. The base station device 260 may be a non-ground base station device (non-ground station device) capable of floating in the air or space. For example, the base station device 260 may be an aircraft station device or a satellite station device.

The aircraft station device is a wireless communication device capable of floating in the atmosphere, such as an aircraft. The aircraft station device may be a device mounted on an aircraft or the like, or may be the aircraft itself. Note that the concept of the aircraft includes not only a heavy aircraft such as an airplane or a glider, but also a light aircraft such as a balloon or an airship. Further, the concept of the aircraft includes not only the heavy aircraft and the light aircraft, but also a rotary-wing aircraft such as a helicopter or an autogyro. Note that the aircraft station device (or the aircraft on which the aircraft station device is mounted) may be an unmanned aerial vehicle (UAV) such as a drone. Note that the concept of the unmanned aerial vehicle also includes an unmanned aircraft system (UAS) and a tethered UAS. The concept of the unmanned aerial vehicle also includes a Lighter than Air UAS (LTA) and a Heavier than Air UAS (HTA). In addition, the concept of the unmanned aerial vehicle also includes high altitude UAS platforms (HAPs).

The satellite station device is a wireless communication device capable of floating outside the atmosphere. The satellite station device may be a device mounted on a space mobile body such as an artificial satellite, or may be the space mobile body itself. A satellite that serves as the satellite station device may be any one of a low earth orbiting (LEO) satellite, a medium earth orbiting (MEO) satellite, a geostationary earth orbiting (GEO) satellite, or a highly elliptical orbiting (HEO) satellite. It is a matter of course that the satellite station device may be a device mounted on the LEO satellite, the MEO satellite, the GEO satellite, or the HEO satellite.

Further, the satellite station device may have a function of a relay station for the ground base station using a vent pipe method.

The size of the coverage of the base station device 260 may be large like a macrocell or may be small like a picocell. It is a matter of course that the size of the coverage of the base station device 260 may be extremely small like a femtocell. Further, the base station device 260 may have a beamforming capability. In this case, the base station device 260 may form a cell or a service area for each beam.

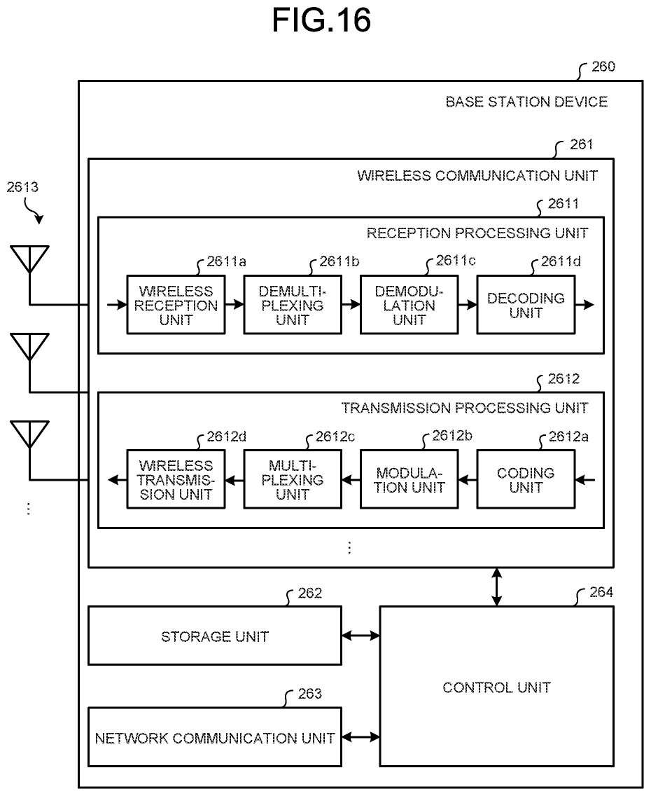

FIG. 16 is a block diagram illustrating a configuration example of the base station device according to the first embodiment of the present disclosure. The base station device 260 includes a wireless communication unit 261, a storage unit 262, a network communication unit 263, and a control unit 264. Note that the configuration illustrated in FIG. 16 is a functional configuration, and a hardware configuration may be different from this. Further, the functions of the base station device 260 may be distributed to and implemented in a plurality of physically separated components.

The wireless communication unit 261 is a wireless communication interface that performs wireless communication with another wireless communication device (for example, the UE 280 and another base station device 260). The wireless communication unit 261 is operated under the control of the control unit 264. Note that the wireless communication unit 261 may support a plurality of radio access schemes. For example, the wireless communication unit 261 may support both NR and LTE. The wireless communication unit 261 may support W-CDMA or cdma2000 in addition to NR or LTE. It is a matter of course that the wireless communication unit 261 may support a radio access scheme other than NR, LTE, W-CDMA, and cdma2000.

The wireless communication unit 261 includes a reception processing unit 2611, a transmission processing unit 2612, and an antenna 2613. The wireless communication unit 261 may include a plurality of reception processing units 2611, a plurality of transmission processing units 2612, and a plurality of antennas 2613. Note that, in a case where the wireless communication unit 261 supports a plurality of radio access schemes, each unit of the wireless communication unit 261 can be individually configured for each radio access scheme. For example, the reception processing unit 2611 and the transmission processing unit 2612 may be individually configured for each of LTE and NR.

The reception processing unit 2611 processes an uplink signal received via the antenna 2613. The reception processing unit 2611 includes a wireless reception unit 2611a, a demultiplexing unit 2611b, a demodulation unit 2611c, and a decoding unit 2611d.

The wireless reception unit 2611a performs, on the uplink signal, down-conversion, removal of an unnecessary frequency component, a control of an amplification level, quadrature demodulation, conversion into a digital signal, removal of a guard interval, extraction of a frequency domain signal by fast Fourier transform, and the like. The demultiplexing unit 2611b separates an uplink channel such as a physical uplink shared channel (PUSCH) or physical uplink control channel (PUCCH) and an uplink reference signal from a signal output from the wireless reception unit 2611a. The demodulation unit 2611c performs demodulation of a received signal for a modulation symbol of the uplink channel by using a modulation scheme such as binary phase shift keying (BPSK) or quadrature phase shift keying (QPSK). The modulation scheme used by the demodulation unit 2611c may be 16-quadrature amplitude modulation (QAM), 64-QAM, or 256-QAM. The decoding unit 2611d performs decoding processing on a coded bit of the demodulated uplink channel. Decoded uplink data and uplink control information are output to the control unit 264.

The transmission processing unit 2612 performs transmission processing of downlink control information and downlink data. The transmission processing unit 2612 includes a coding unit 2612a, a modulation unit 2612b, a multiplexing unit 2612c, and a wireless transmission unit 2612d.

The coding unit 2612a codes the downlink control information and the downlink data input from the control unit 264 by using a coding scheme such as block coding, convolutional coding, turbo coding, low-density parity-check (LDPC) coding, or polar coding. The modulation unit 2612b modulates the coded bit output from the coding unit 2612a by a predetermined modulation scheme such as BPSK, QPSK, 16-QAM, 64-QAM, or 256-QAM. The multiplexing unit 2612c multiplexes a modulation symbol of each channel and a downlink reference signal, and maps them to a predetermined resource element. The wireless transmission unit 2612d performs various kinds of signal processing on a signal from the multiplexing unit 2612c. For example, the wireless transmission unit 2612d performs processing such as conversion into the time domain by fast Fourier transform, addition of a guard interval, generation of a baseband digital signal, conversion into an analog signal, quadrature modulation, up-conversion, removal of extra frequency components, or power amplification. A signal generated by the transmission processing unit 2612 is transmitted from the antenna 2613.

The storage unit 262 is a storage device, from which data can be read and in which data can be written, such as a DRAM, an SRAM, a flash memory, or a hard disk. The storage unit 262 functions as storage means of the base station device 260.

The network communication unit 263 is a communication interface for performing communication with other devices (for example, the control device 223, another base station device 260, the cloud server 240, and the like). The network communication unit 263 has a function of establishing direct or indirect connection to the first and second Internet lines 20₁ and 20₂. For example, the network communication unit 263 includes a LAN interface such as an NIC. Further, the network communication unit 23 may be a wired interface or a wireless interface. The network communication unit 263 functions as network communication means of the base station device 260. The network communication unit 263 performs communication with another device under the control of the control unit 264. The configuration of the network communication unit 263 may be similar to that of the network communication unit 2221 of the authentication device 221.

The control unit 264 is a controller that controls each unit of the base station device 260. The control unit 264 is implemented by, for example, a processor such as a CPU or an MPU. For example, the control unit 264 is implemented in a manner in which the processor executes various programs stored in the storage device inside the base station device 260 by using a RAM or the like as a work area. Note that the control unit 264 may be implemented by an integrated circuit such as an ASIC or a FPGA. The CPU, the MPU, the ASIC, and the FPGA can all be regarded as the controller.

The control unit 264 acquires, from the control device 223, for example, information (device information) regarding the cloud server 240A selected as the construction server by the control device 223. The control unit 264 accesses the cloud server 240A based on the acquired device information to establish connection to the virtual core network 225. As a result, the base station device 260 provides the cellular service to the UE 280 by using the virtual core network 225.

### 3.1.6. Configuration Example of UE

The UE 280 (hereinafter, also referred to as a mobile device 280) is a movable wireless communication device that performs wireless communication with the base station device 260. The mobile device 280 is, for example, a mobile phone, a smart device (smartphone or tablet PC), a personal digital assistant (PDA), or a personal computer. The mobile device 280 may be a machine-to-machine (M2M) device or an Internet of Things (IoT) device. For example, the mobile device 280 may be a head-mounted display (HMD) or a headset for virtual reality (VR), augmented reality (R), mixed reality (MR), substitutional reality (SR), or X reality (XR). In this case, the MEC 160 illustrated in FIG. 3 is, for example, a server that processes a moving image of VR, AR, MR, SR, or XR.

Note that the mobile device 280 may be a wireless communication device installed on a mobile body, or may be the mobile body itself. For example, the mobile device 280 may be a vehicle that moves on a road, such as an automobile, a bus, a truck, or a motorcycle, or a vehicle that moves on a track called a rail, such as a railway, or may be a wireless communication device mounted on the vehicle. The mobile device 280 may be able to perform communication (sidelink) with another mobile device 280.

Note that the “mobile device” is a type of communication device, and is also referred to as a mobile station, a mobile station device, a terminal device, or a terminal. The concept of the “mobile device” includes not only a communication device configured to be movable but also a mobile body in which the communication device is installed. Here, the mobile body may be a mobile terminal, or may be a mobile body that moves on land (on the ground in a narrow sense), in the ground, on water, or under water. Furthermore, the mobile body may be a mobile body that moves inside the atmosphere, such as a drone or a helicopter, or may be a mobile body that moves outside the atmosphere, such as an artificial satellite.

In the present embodiment, the concept of the communication device includes not only a portable mobile device (terminal device) such as a mobile terminal but also a device installed in a structure or mobile body. The structure or mobile body itself may be regarded as the communication device. Furthermore, the concept of the communication device includes not only a mobile device (a terminal device, an automobile, or the like) but also a base station device (a donor base station, a relay base station, or the like). The communication device is a type of processing device and information processing device.

The mobile device 280 and the base station device 260 are connected to each other by wireless communication (for example, radio waves or radio over fiber). In a case where the mobile device 280 moves from a communication area (or cell) of a certain base station device to a communication area (or cell) of another base station device, handover (or handoff) is performed.

The mobile device 280 may be simultaneously connected to a plurality of base station devices or a plurality of cells to perform communication. For example, in a case where one base station device 260 supports a communication area via a plurality of cells (for example, pCell or sCell), it is possible to bundle the plurality of cells and enable communication between the mobile device 280 and the base station device 260 by using carrier aggregation (CA) technology, dual connectivity (DC) technology, or multi-connectivity (MC) technology. Alternatively, a mobile device 50 and the plurality of base station devices can perform communication with each other by using coordinated multi-point transmission and reception (CoMP) technology via cells of different base station devices 260.

Note that the mobile device 280 is not necessarily a device directly used by a person. The mobile device 280 may be a sensor installed in a machine of a factory like so-called machine type communication (MTC). Further, the mobile device 280 may be an M2M device or an IoT device. Furthermore, the mobile device 280 may be a device having a relay communication function as represented by device-to-device (D2D) and vehicle-to-everything (V2X). Further, the mobile device 280 may be a device that is called client premises equipment (CPE) used in a wireless backhaul or the like. Furthermore, the mobile device 280 may be a robot itself that wirelessly controls its operation, or may be an actuator that wirelessly implements a partial operation of the robot.

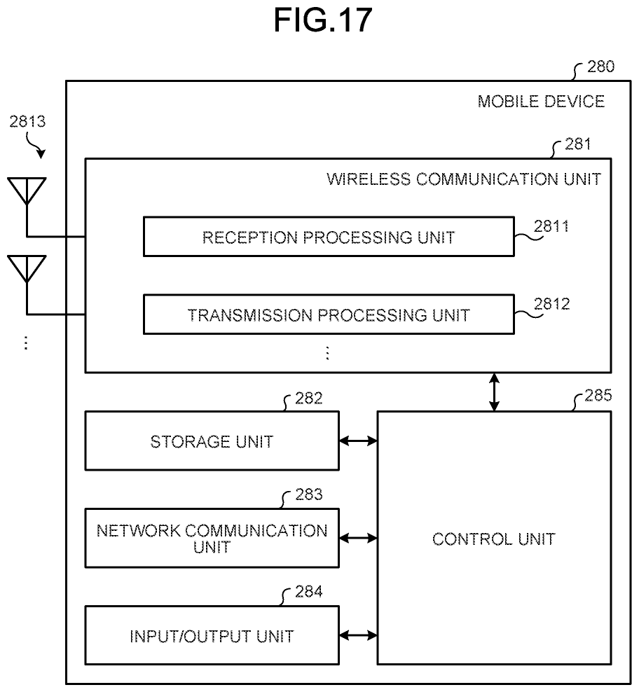

FIG. 17 is a diagram illustrating a configuration example of the mobile device 280 according to the embodiment of the present disclosure. The mobile device 280 includes a wireless communication unit 281, a storage unit 282, a network communication unit 283, an input/output unit 284, and a control unit 285. Note that the configuration illustrated in FIG. 17 is a functional configuration, and a hardware configuration may be different from this. Further, the functions of the mobile device 280 may be distributed to and implemented in a plurality of physically separated components.

The wireless communication unit 281 is a wireless communication interface that performs wireless communication with another wireless communication device (for example, the base station device 260). The wireless communication unit 281 is operated under the control of the control unit 285. The wireless communication unit 281 supports one or more radio access schemes. For example, the wireless communication unit 51 supports both NR and LTE. The wireless communication unit 281 may support W-CDMA or cdma2000 in addition to NR or LTE.

The wireless communication unit 281 includes a reception processing unit 2811, a transmission processing unit 2812, and an antenna 2813. The wireless communication unit 281 may include a plurality of reception processing units 2811, a plurality of transmission processing units 2812, and a plurality of antennas 2813. Note that, in a case where the wireless communication unit 281 supports a plurality of radio access schemes, each unit of the wireless communication unit 281 can be individually configured for each radio access scheme. For example, the reception processing unit 2811 and the transmission processing unit 2812 may be individually configured for each of LTE and NR.

The reception processing unit 2811 processes a downlink signal received via the antenna 2813. The reception processing unit 2811 includes a wireless reception unit 2811a, a demultiplexing unit 2811b, a demodulation unit 2811c, and a decoding unit 2811d.

The wireless reception unit 2811a performs, on the downlink signal, down-conversion, removal of an unnecessary frequency component, a control of an amplification level, quadrature demodulation, conversion into a digital signal, removal of a guard interval, extraction of a frequency domain signal by fast Fourier transform, and the like. The demultiplexing unit 2811b separates a downlink channel, a downlink synchronization signal, and a downlink reference signal from the signal output from the wireless reception unit 2811a. The downlink channel is, for example, a channel such as a physical broadcast channel (PBCH), a physical downlink shared channel (PDSCH), or a physical downlink control channel (PDSCH). A demodulation unit 211c performs demodulation on the received signal for a modulation symbol of the downlink channel by using a modulation scheme such as BPSK, QPSK, 16Q-AM, 64-QAM, or 256-QAM. The decoding unit 2811d performs decoding processing on a coded bit of the demodulated downlink channel. Decoded downlink data and downlink control information are output to the control unit 285.

The transmission processing unit 2812 performs transmission processing of uplink control information and uplink data. The transmission processing unit 2812 includes a coding unit 2812a, a modulation unit 2812b, a multiplexing unit 2812c, and a wireless transmission unit 2812d.

The coding unit 2812a codes the uplink control information and the uplink data input from the control unit 285 by using a coding scheme such as block coding, convolutional coding, turbo coding, LDPC coding, or polar coding. The modulation unit 2812b modulates the coded bit output from the coding unit 2812a by a predetermined modulation scheme such as BPSK, QPSK, 16-QAM, 64-QAM, or 256-QAM. The multiplexing unit 2812c multiplexes a modulation symbol of each channel and an uplink reference signal, and maps them to a predetermined resource element. The wireless transmission unit 2812d performs various kinds of signal processing on a signal from the multiplexing unit 2812c. For example, the wireless transmission unit 2812d performs processing such as conversion into the time domain by inverse fast Fourier transform, addition of a guard interval, generation of a baseband digital signal, conversion into an analog signal, quadrature modulation, up-conversion, removal of extra frequency components, or power amplification. A signal generated by the transmission processing unit 2812 is transmitted from the antenna 2813.

The storage unit 282 is a storage device, from which data can be read and in which data can be written, such as a DRAM, an SRAM, a flash memory, or a hard disk. The storage unit 282 functions as storage means of the mobile device 280.

The network communication unit 283 is a communication interface for performing communication with another device. For example, the network communication unit 283 is a LAN interface such as an NIC. The network communication unit 283 has a function of establishing direct or indirect connection to a network N1. Further, the network communication unit 283 may be a wired interface or a wireless interface. The network communication unit 283 functions as network communication means of the mobile device 280. The network communication unit 283 performs communication with another device under the control of the control unit 285.

The input/output unit 284 is a user interface for exchanging information with the user. For example, the input/output unit 284 is an operation device for the user to perform various operations, such as a keyboard, a mouse, an operation key, a game controller, or a touch panel. Alternatively, the input/output unit 284 is a display device such as a liquid crystal display or an organic electroluminescence (EL) display. The input/output unit 284 may be an audio device such as a speaker or a buzzer. Further, the input/output unit 284 may be a lighting device such as a light emitting diode (LED) lamp. The input/output unit 284 functions as input/output means (input means, output means, operation means, or notification means) of the mobile device 280.

The control unit 285 is a controller that controls each unit of the mobile device 280. The control unit 285 is implemented by, for example, a processor such as a CPU or an MPU. For example, the control unit 285 is implemented in a manner in which the processor executes various programs stored in the storage device inside the mobile device 280 by using a RAM or the like as a work area. Note that the control unit 285 may be implemented by an integrated circuit such as an ASIC or a FPGA. The CPU, the MPU, the ASIC, and the FPGA can all be regarded as the controller.

The control unit 285 performs communication with the base station device 260 to access the virtual core network 225 constructed in the cloud server 240 by the control device 223, and teaches the cellular service provided by the virtual core network 225 via the base station device 260.

### 3.2. Virtual Core Network Construction Processing

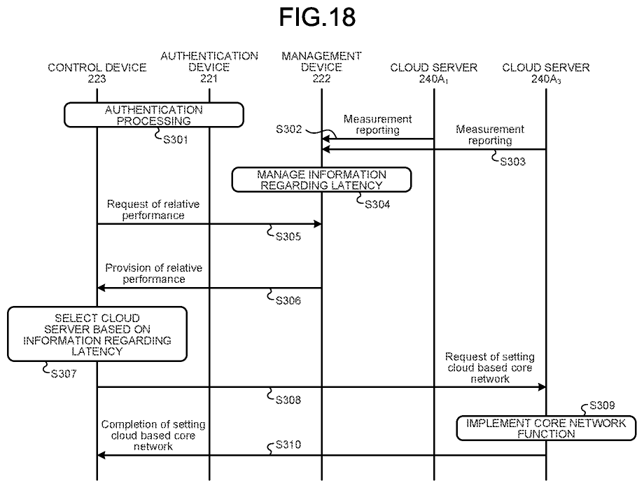

FIG. 18 is a sequence diagram illustrating an example of a signaling flow of the communication system S1 according to the first embodiment of the present disclosure.

As illustrated in FIG. 18, the control device 223 performs authentication processing with the authentication device 221 (Step S301). It is assumed that the control device 223 has been authenticated as a device that can be connected to the first Internet line 20₁ as a result of the authentication processing. In this case, the control device 223 can use the network function in the first Internet line 20₁, for example, the management device 222 or the cloud server 240A.

The management device 222 acquires the information regarding the processing quality, for example, the information regarding the latency, as Measurement reporting from the cloud server 240A₁ (Step S302). Similarly, the management device 222 acquires the information regarding the processing quality, for example, the information regarding the latency, as Measurement reporting from the cloud server 240A₃ (Step S303). Although not illustrated, the cloud servers 240A₂ and 240A₄ connected to the first Internet line 20₁ similarly perform Measurement reporting for the management device 222.

Here, the cloud server 240A may perform the Measurement reporting in response to a request from the management device 222 or in accordance with a setting. Alternatively, the cloud server 240A may perform the Measurement reporting on a preset fixed or variable cycle. For example, the cloud server 240A may perform the Measurement reporting in an event in which the latency is changed by a certain amount.

The management device 222 acquires the Measurement reporting from the cloud server 240A and manages the information regarding the processing quality, for example, the information regarding the latency (Step S304). Note that the information regarding the processing quality included in the Measurement reporting may include not only the information regarding the latency but also the information regarding the processing speed or the available capacity. In this case, the management device 222 manages information regarding the dynamic processing capability of each cloud server 240A. It is assumed that, for example, the management device 222 sets, in advance, a characteristic (for example, the latency or the dynamic processing capability) to be measured, a reporting frequency, or an event for the cloud server 240A.

The control device 223 transmits a Request of relative performance message to the management device 222 (Step S305). In a case where the management device 222 manages information regarding a plurality of characteristics as the processing qualities of the cloud server 240A, the control device 223 may specify information desired to be acquired, for example, the information regarding the latency, by using the Request of relative performance message.

The management device 222 makes a notification of the information regarding the processing quality of the cloud server 240A as a response to the Request of relative performance message (Step S306). When the control device 223 specifies the information desired to be acquired in the Request of relative performance message, the management device 222 makes a notification of the information specified in the Request of relative performance message (for example, the information regarding the latency).

The control device 223 selects the cloud server 240A in which the virtual core network 225 is to be constructed based on the acquired information regarding the processing quality (Step S307). For example, in a case where the information regarding the latency is acquired from the management device 222, the control device 223 selects the cloud server 240A₃ with the lowest latency.

The control device 223 transmits a Request of setting cloud based core network message to the selected cloud server 240A₃ (Step S308).

Once the Request of setting cloud based core network message is received, the cloud server 240A₃ implements the network function of the virtual core network 225 by using the virtualization technology (Step S309).

The cloud server 240A₃ may implement all the network functions illustrated in FIG. 3, or may implement some of the network functions, for example, the functions of the UPF 121 and the MEC 160. The control device 223 may specify the network function to be implemented by the cloud server 240A₃ by using the Request of setting cloud based core network message. Alternatively, by using the Request of setting cloud based core network message as a trigger, the control device 223 may specify the network function by causing the cloud server 240A₃ to download a setting file including the type of network function to be implemented.

Once the implementation of the network function of the virtual core network 225 is completed, the cloud server 240A₃ transmits a Completion of setting cloud based core network message to the control device 223 (Step S310).

Note that, here, the control device 223 selects the cloud server 240A in which the virtual core network 225 is to be constructed according to the latency of the cloud server 240A, but the present disclosure is not limited thereto. The control device 223 may select the cloud server 240A having the highest processing capability, for example, the highest processing speed, based on the information regarding the processing quality of the cloud server 240A, for example, the dynamic processing capability described above.

As described above, the control device 223 according to the first embodiment of the present disclosure is connected to the plurality of cloud servers 240A (an example of the processing device) and the base station device 260 via the first Internet line 20₁ (an example of the network). The control unit 2233 of the control device 223 acquires the information regarding the processing quality of the plurality of cloud servers 240A from the management device 222. The control unit 2233 selects the cloud server 240A that is to execute at least one function of the virtual core network (an example of the core network) connected to the base station device 260 from among the plurality of cloud servers 240A based on the acquired processing quality.

As a result, the control device 223 can construct the virtual core network 225 with lower latency in the cloud server 240A.

### 4. Second Embodiment

In the first embodiment, an example in which the control device 223 constructs the virtual core network 225 in the cloud server 240A connected to the first Internet line 20₁ to which the control device 223 itself is connected has been described. In addition to the above-described example, an example in which the control device 223 constructs the virtual core network 225 in the cloud server 240B connected to the second Internet line 20₂ to which the base station device 260 is connected is also possible.

Therefore, in a second embodiment, a case where the control device 223 selects a construction server in which the virtual core network 225 is to be constructed from among a plurality of cloud servers 240B connected to the second Internet line 20₂ will be described.

### 4.1. Configuration Example of Communication System

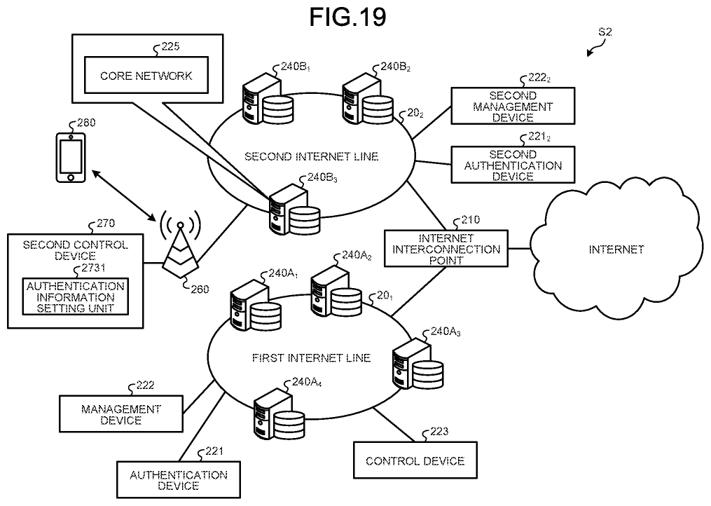

FIG. 19 is a diagram illustrating a configuration example of a communication system S2 according to the second embodiment of the present disclosure. The communication system S2 includes a second authentication device 2212, a second management device 2222, and a second control device 270 in addition to the configuration of the communication system S1 illustrated in FIG. 6.

The second authentication device 2212 and the second management device 222₂ are connected to the second Internet line 20₂. The second control device 270 is connected to the base station device 260.

The second authentication device 2212 performs authentication to check, for example, whether or not the base station device 260 can be connected to the second Internet line 20₂. The second authentication device 2212 may have a configuration similar to that of the authentication device 221 illustrated in FIG. 7, for example.

The second management device 222₂ acquires and manages information regarding a processing quality of the cloud server 240B in the second Internet line 20₂. In addition, the second management device 222₂ acquires and manages information regarding the cloud server 240B, for example, information for another device to access the cloud server 240B, such as an IP address and a port number.

Here, information regarding latency among processing qualities of the cloud server 240B acquired and managed by the second management device 222₂ is information regarding latency with respect to an arbitrary reference point set by the second management device 222₂. The second management device 222₂ instructs the cloud server 240B to measure the latency between the cloud server 240B and the arbitrary reference point by using, for example, ping. Here, the second management device 222₂ sets the base station device 260 as the arbitrary reference point. The arbitrary reference point is set using, for example, the IP address of the base station device 260.

Note that the second management device 222₂ may have a configuration similar to that of the management device 222 illustrated in FIG. 8, for example. Furthermore, the second management device 222₂ may acquire, as the processing quality, not only the above-described latency characteristics but also information regarding a dynamic processing capability such as information regarding a processing speed and a capacity of the cloud server 240B, for example.

The second control device 270 collects the information regarding the processing quality, makes a request for constructing a virtual core network 225 in the cloud server 240B, and the like, with respect to the second management device 222₂ and the cloud server 240B, on behalf of the control device 223. The second control device 270 notifies the control device 223 of the collected information. In other words, the second control device 270 functions as a relay device that relays communication between the control device 223, and the second management device 222₂ and the cloud server 240B, or an entity that negotiates and makes an indirect request with respect to the second management device 222₂ and the cloud server 240B on behalf of the control device 223.

The control device 223 has a contract for using the first Internet line 20₁, but does not have a contract for using the second Internet line 20₂. Therefore, the second control device 270 having a contract for using the second Internet line 20₂ performs communication with the second management device 222₂ and the cloud server 240B instead of the control device 223. As a result, similarly to the first embodiment, the control device 223 can acquire information from the second management device 222₂ and select the construction server.

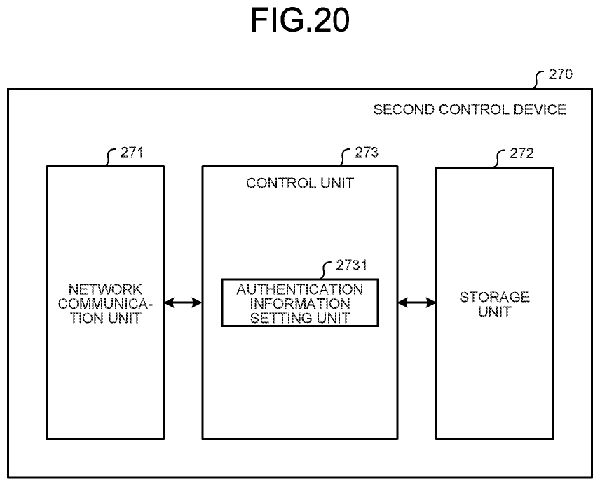

FIG. 20 is a block diagram illustrating a configuration example of the second control device 270 according to the second embodiment of the present disclosure. The second control device 270 includes a network communication unit 271, a storage unit 272, and a control unit 273. Note that the configuration illustrated in FIG. 20 is a functional configuration, and a hardware configuration may be different from this. Further, the functions of the second control device 270 may be distributed to and implemented in a plurality of physically separated components. For example, the second control device 270 may include a plurality of server devices. Further, the functions of the second control device 270 may be dynamically distributed to and implemented in a plurality of physically separated components.

The network communication unit 271 is a communication interface for performing communication with another device. Note that a configuration of the network communication unit 271 may be similar to the configuration of the network communication unit 2231 of the control device 223. The network communication unit 271 functions as communication means of the second control device 270. The network communication unit 271 performs communication with the second authentication device 2212, the second management device 222₂, and the cloud server 240B under the control of the control unit 273.

The storage unit 272 is a data readable/writable storage device such as a DRAM, an SRAM, a flash memory, or a hard disk. The storage unit 272 functions as storage means of the second control device 270.

The control unit 273 is a controller that controls each unit of the second control device 270. The control unit 273 is implemented by, for example, a processor such as a CPU or an MPU. For example, the control unit 273 is implemented in a manner in which the processor executes various programs stored in the storage device inside the second control device 270 by using a RAM or the like as a work area. Note that the control unit 273 may be implemented by an integrated circuit such as an ASIC or a FPGA. The CPU, the MPU, the ASIC, and the FPGA can all be regarded as the controller.

The control unit 273 includes an authentication information setting unit 2731. The authentication information setting unit 2731 sets authentication information necessary for connection to the second Internet line 20₂.

The control unit 273 acquires the information from the second management device 222₂, for example, and transfers the information to the control device 223. Furthermore, the control unit 273 transfers, for example, the notification from the control device 223 to the second management device 222₂ or the cloud server 240B. In addition, the control unit 273 makes a request to the second management device 222₂ or the cloud server 240B on behalf of the control device 223.

Note that some functions of the second control device 270, for example, a function of making a request for constructing the virtual core network 225 to the cloud server 240B selected by the control device 223, may be implemented as the function of the AF 149 illustrated in FIGS. 2 and 3. In addition, the second control device 270 may be configured as a part of the base station device 260.

The control device 223 acquires the information regarding the processing quality of the cloud server 240B from the second management device 222₂ via the second control device 270. The control device 223 selects the cloud server 240B in which the virtual core network 225 is to be constructed based on the acquired information. Note that a method of selecting the construction server by the control device 223 is the same as that in the first embodiment except that the selected target is changed from the cloud server 240A to the cloud server 240B.

The control device 223 makes a request for implementing the virtual core network 225 to the selected cloud server 240B via the second control device 270.

The cloud server 240B is a processing device connected to the second Internet line 20₂. The cloud server 240B measures the processing quality based on, for example, an instruction from the second management device 222₂, and notifies the second management device 222₂ of the processing quality. In addition, the cloud server 240B implements some or all of the functions of the virtual core network 225 in accordance with an instruction from the second control device 270 that mediates an instruction from the control device 223. Note that the cloud server 240B may have a configuration similar to that of the cloud server 240A illustrated in FIG. 15.

### 4.2. Virtual Core Network Construction Processing

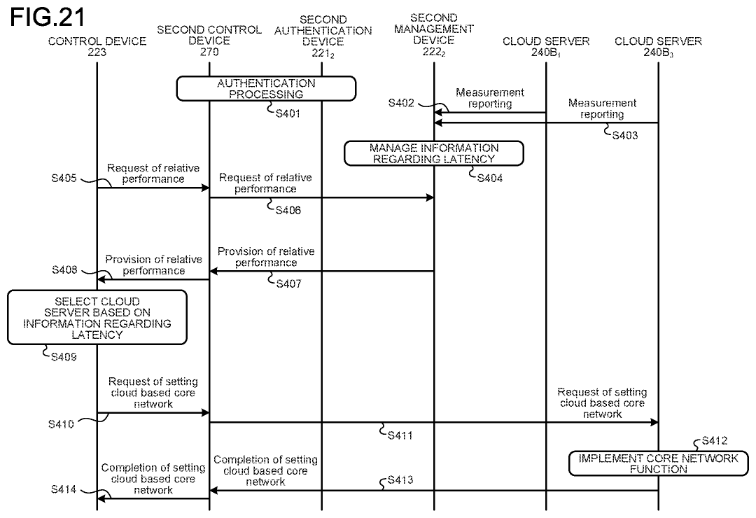

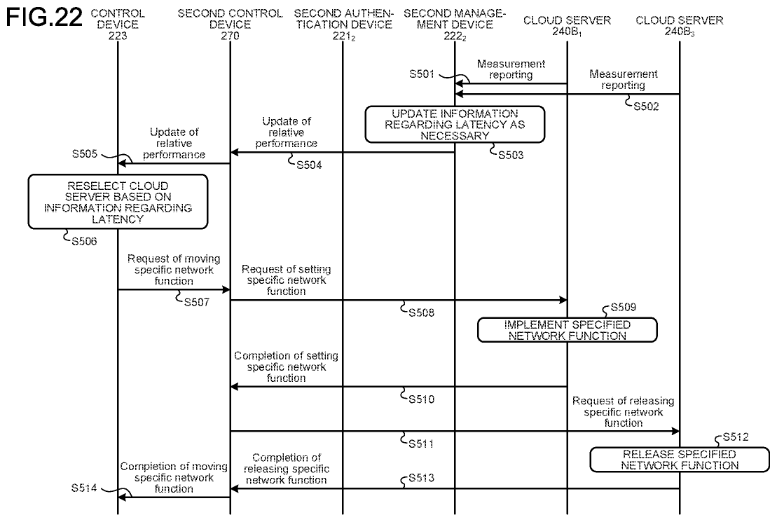

FIG. 21 is a sequence diagram illustrating an example of a signaling flow of the communication system S2 according to the second embodiment of the present disclosure.

As illustrated in FIG. 21, the second control device 270 performs authentication processing with the second authentication device 2212 (Step S401). It is assumed that a second control device 270 has been authenticated as a device that can be connected to the second Internet line 20₂ as a result of the authentication processing. In this case, the second control device 270 can use the network function in the second Internet line 20₂, for example, the second management device 222₂ or the cloud server 240B.

The second management device 222₂ acquires the information regarding the processing quality, for example, the information regarding the latency, as Measurement reporting from a cloud server 240B₁ (Step S402). Similarly, the second management device 222₂ acquires the information regarding the processing quality, for example, the information regarding the latency, as the Measurement reporting from a cloud server 240B₃ (Step S403). Although not illustrated, a cloud server 240B₂ connected to the second Internet line 20₂ similarly performs Measurement reporting for the second management device 222₂.

Here, the cloud server 240B may perform the Measurement reporting in response to a request from the second management device 222₂ or in accordance with a setting. Alternatively, the cloud server 240B may perform the Measurement reporting on a preset fixed or variable cycle. For example, the cloud server 240B may perform the Measurement reporting in an event in which the latency is changed by a certain amount.

The second management device 222₂ acquires the Measurement reporting from the cloud server 240B, and manages the information regarding the processing quality, for example, the information regarding the latency (Step S404). Note that the information regarding the processing quality included in the Measurement reporting may include not only the information regarding the latency but also the information regarding the processing speed or the available capacity. In this case, the second management device 222₂ manages information regarding the dynamic processing capability of each cloud server 240B. It is assumed that, for example, the second management device 222₂ sets, in advance, a characteristic (for example, the latency or the dynamic processing capability) to be measured, a reporting frequency, or an event in the cloud server 240B.

The control device 223 transmits a Request of relative performance message to the second control device 270 (Step S405). In a case where the second management device 222₂ manages information regarding a plurality of characteristics as the processing qualities of the cloud server 240B, the control device 223 may specify information desired to be acquired, for example, the information regarding the latency, by using the Request of relative performance message. The second control device 270 transfers the Request of relative performance message to the second management device 222₂ (Step S406).

Once the Request of relative performance message is received, the second management device 222₂ transmits information regarding the specified processing quality to the second control device 270 as a response to the Request of relative performance message (Step S407). The second control device 270 transfers the received information regarding the processing quality to the control device 223 (Step S408).

The control device 223 selects the cloud server 240B in which the virtual core network 225 is to be constructed based on the acquired information regarding the processing quality (Step S409). For example, in a case where the information regarding the latency is acquired from the second management device 222₂, the control device 223 selects the cloud server 240B₃ with the lowest latency.

The control device 223 transmits, to the second control device 270, a Request of setting cloud based core network message addressed to the selected cloud server 240B₃ (Step S410). The second control device 270 transfers the Request of setting cloud based core network message to the cloud server 240B₃ (Step S411).

Once the Request of setting cloud based core network message is received, the cloud server 240B₃ implements the network function of the virtual core network 225 by using the virtualization technology (Step S412).

The cloud server 240B₃ may implement all the network functions illustrated in FIG. 3, or may implement some of the network functions, for example, the functions of the UPF 121 and the MEC 160. The control device 223 may specify the network function to be implemented by the cloud server 240B₃ by using the Request of setting cloud based core network message. Alternatively, by using the Request of setting cloud based core network message as a trigger, the control device 223 or the second control device 270 (on behalf of the control device 223) may specify the network function by causing the cloud server 240B₃ to download a setting file including the type of network function to be implemented.

Once the implementation of the network function of the virtual core network 225 is completed, the cloud server 240B₃ transmits a Completion of setting cloud based core network message to the second control device 270 (Step S413). The second control device 270 transfers the Completion of setting cloud based core network message to the control device 223 (Step S414).

In this manner, the control device 223 performs communication with the second management device 222₂ and the cloud server 240B via the second control device 270. As a result, the control device 223 can construct the virtual core network 225 in the cloud server 240B of the second Internet line 20₂ different from the first Internet line 20₁ to which the control device 223 itself is connected.

For example, as illustrated in FIG. 20, in a case where the base station device 260 is connected to the second Internet line 20₂, the virtual core network 225 can be constructed on the same network as that of the base station device 260. As a result, the control device 223 can construct the virtual core network 225 with lower latency.

Note that, here, although the control device 223 selects the construction server from among the cloud servers 240B connected to the second Internet line 20₂, the present disclosure is not limited thereto. The control device 223 may select the construction server from the cloud server 240A connected to the first Internet line 20₁ and the cloud server 240B connected to the second Internet line 20₂.

In this case, the control device 223 may select one cloud server 240 as the construction server from among the plurality of cloud servers 240, and implement all the functions of the virtual core network 225 in the selected cloud server 240.

Alternatively, the control device 223 may select a plurality of cloud servers 240 as the construction servers from among the plurality of cloud servers 240, and implement the functions of the virtual core network 225 in the selected plurality of cloud servers 240 in a distributed manner. For example, the control device 223 may select the construction servers from each of the cloud servers 240A connected to the first Internet line 20₁ and the cloud servers 240B connected to the second Internet line 20₂. In this case, the control device 223 implements a function that greatly affects the latency of the virtual core network 225 in the cloud server 240 whose latency with respect to the base station device 260 is low. For example, the control device 223 implements the function of the user plane function group in the cloud server 240B connected to the same second Internet line 20₂ as that of the base station device 260, and implements other functions in the cloud server 240A connected to the first Internet line 20₁. Alternatively, the control device 223 may implement, for example, the functions of the AMF 141 and the SMF 142 in the cloud server 240B, and implement other functions in the cloud server 240A.

As a result, the control device 223 can construct the virtual core network 225 with lower latency.

In addition, as described above, in a case where the core network operator has a contract for using the first Internet line 20₁ but does not have a contract for using the second Internet line 20₂, there is a possibility that the use of the cloud server 240B is limited. For example, the capacity of the cloud server 240B available to the core network operator may be limited, or the use of the cloud server 240B may be costly.

The control device 223 of the present embodiment implements some of the functions of the virtual core network 225 in the cloud server 240B connected to the second Internet line 20₂, and implements other functions in the cloud server 240A connected to the first Internet line 20₁. As a result, the capacity of the cloud server 240B used for constructing the virtual core network 225 can be reduced, and the cost required for constructing the virtual core network 225 can be reduced.

### 5. Modified Example

### 5.1. First Modified Example

In the first and second embodiments, the case where the control device 223 selects the cloud server 240 in which the virtual core network 225 is to be constructed, and the virtual core network 225 is constructed in the selected cloud server 240 has been described. In addition to the above example, an example in which the control device 223 reselects the cloud server 240 after constructing the virtual core network 225 is also possible.

Therefore, in a first modified example, a case where the control device 223 constructs the virtual core network 225 in the cloud server 240B₃ and then reselects the construction server will be described.

FIG. 22 is a sequence diagram illustrating an example of a signaling flow of a communication system according to the first modified example of the present disclosure. Such a signaling flow is executed following the signaling flow illustrated in FIG. 21.

Even after the virtual core network 225 has been constructed in the cloud server 240B₃, the second management device 222₂ acquires, as the Measurement reporting, the information regarding the processing quality, for example, the information regarding the latency, from the cloud server 240B₁ (Step S501). Similarly, the second management device 222₂ acquires the information regarding the processing quality, for example, the information regarding the latency, as the Measurement reporting from the cloud server 240B₃ (Step S502). Although not illustrated, a cloud server 240B₂ connected to the second Internet line 20₂ similarly performs Measurement reporting for the second management device 222₂.

The second management device 222₂ acquires the Measurement reporting from the cloud server 240B, and updates the information regarding the processing quality, for example, the information regarding the latency (Step S503). Note that the information regarding the processing quality included in the Measurement reporting may include not only the information regarding the latency but also the information regarding the processing speed or the available capacity.

The second management device 222₂ transmits an Update of relative performance message to the second control device 270 (Step S504). The Update of relative performance message includes, for example, the updated information regarding the processing quality. The second management device 222₂ transmits the Update of relative performance message, for example, in response to an event in which the processing quality is changed. The second control device 270 transfers the Update of relative performance message to the control device 223 (Step S505).

The control device 223 reselects the cloud server 240B in which the virtual core network 225 is to be constructed based on the updated information regarding the processing quality (Step S506). In a case where the reselected cloud server 240B is the same as the cloud server 240B₃ in which the virtual core network 225 is constructed, the control device 223 continuously uses the cloud server 240B₃ as the construction server.

Meanwhile, a case where the control device 223 reselects, as the construction server, for example, the cloud server 240B₁ different from the cloud server 240B₃ in which the virtual core network 225 is constructed is assumed. In this case, the control device 223 moves the function of the virtual core network 225 from the cloud server 240B₃ to the cloud server 240B₁. Specifically, the control device 223 transmits a Request of moving specific network function message to the second control device 270 (Step S507). The second control device 270 notifies the cloud server 240B₁, which is a destination to which the virtual core network 225 is to be moved, of the Request of moving specific network function message (Step S508).

Here, the control device 223 transmits the Request of moving specific network function message including information regarding the cloud server 240B₁ which is the destination to which the virtual core network 225 is to be moved. In addition, the control device 223 may specify the function of the virtual core network 225 to be moved by using the Request of moving specific network function message. In this case, the control device 223 may select the cloud server 240B to which each network function is to be moved for each network function of the virtual core network 225, for example.

Once the implementation of the specified network function is completed (Step S509), the cloud server 240B₁ transmits a Completion of setting specific network function message as a response to the second control device 270 (Step S510).

Once the Completion of setting specific network function message is received, the second control device 270 transmits a Request of releasing specific network function message that instructs release of the specified network function to the cloud server 240B₃ (Step S511).

Note that, here, the second control device 270 that has received the Completion of setting specific network function message transmits the Request of releasing specific network function message to the cloud server 240B₃, but the present disclosure is not limited thereto. For example, the second control device 270 may transfer the Completion of setting specific network function message to the control device 223. In this case, the control device 223 transmits the Request of releasing specific network function message to the cloud server 240B₃ via the second control device 270.

Once the release of the specified network function is completed (Step S512), the cloud server 240B₃ transmits a Completion of releasing specific network function message as a response to the second control device 270 (Step S513). The second control device 270 transfers the Completion of releasing specific network function message to the control device 223 (Step S514).

As described above, when the processing quality of the cloud server 240B is updated, the cloud server 240B that is to execute the function of the virtual core network 225 is reselected from among the plurality of cloud servers 240B according to the updated processing quality.

As a result, the control device 223 can construct the cloud-based virtual core network 225 that is flexible with respect to the local cellular network in consideration of the dynamic load status of the cloud server 240B.

Note that, here, the modified example of the second embodiment, that is, a case where the control device 223 reselects the cloud server 240B has been described, but the present disclosure is not limited thereto. The first modified example may be applied to the first embodiment, that is, the control device 223 may reselect the cloud server 240A according to the processing quality updated by the management device 222.

### 5.2. Other Modified Examples

In the first and second embodiments and the first modified example, the case where the control device 223 constructs the 5GC/NGC 100 as the virtual core network 225 has been described, but the present disclosure is not limited thereto. For example, the control device 223 may construct a core network other than 5G, such as an evolved packet core (EPC), in the cloud server 240 by virtualizing the core network.

In the first and second embodiments and the first modified example, the case where the control device 223 constructs the virtual core network 225 in the cloud server 240 of the first Internet line 20₁ to which the control device 223 itself is connected or the second Internet line 20₂ to which the base station device 260 is connected has been described, but the present disclosure is not limited thereto. The control device 223 may construct the virtual core network 225 in a cloud server 240C (not illustrated) of a network to which neither the control device 223 itself nor the base station device 260 is directly connected, for example, a third Internet line (not illustrated). For example, in a case where the second Internet line 20₂ to which the base station device 260 is connected and the third Internet line are networks of a country different from that of the first Internet line 20₁ to which the control device 223 itself is connected, and the first Internet line 20₁ has a roaming agreement with the third Internet line, the control device 223 can construct the virtual core network 225 in the cloud server 240C (not illustrated) of the third Internet line (not illustrated).

In this case, a third management device (not illustrated) connected to the third Internet line manages information regarding a processing capability of the cloud server 240C. In a case where the information regarding the processing quality is information regarding latency, the third management device acquires and manages, for example, information regarding latency between the cloud server 240C and the base station device 260, more specifically, latency between the cloud server 240C and the Internet interconnection point 210.

In the first and second embodiments and the first modified example, the case where the core network operator provides the local cellular network to the user has been described, but the present disclosure is not limited thereto. For example, the core network operator may utilize the technology of the present disclosure to provide a wide area cellular network to the user. For example, in the wide area cellular network, the technology of the present disclosure may also be utilized when providing a certain low-latency service locally and dynamically.

The control device that controls the authentication device 221, the management device 222, the control device 223, the cloud server 240, the base station device 260, the mobile device 280, or the like of the first and second embodiments and the first modified example may be implemented by a dedicated computer system or a general-purpose computer system.

For example, a program for performing the above-described operations is stored in a computer-readable recording medium such as an optical disk, a semiconductor memory, a magnetic tape, or a flexible disk, and distributed. Then, for example, the control device is implemented by installing the program in a computer and performing the above-described processing. At this time, the control device may be a device (for example, a personal computer) outside the authentication device 221, the management device 222, the control device 223, the cloud server 240, the base station device 260, the mobile device 280, or the like. Furthermore, the control device may be a device (for example, the control unit 2213, the control unit 2223, the control unit 2233, the control unit 2403, the control unit 264, or the control unit 285) inside the authentication device 221, the management device 222, the control device 223, the cloud server 240, the base station device 260, the mobile device 280, or the like.

Further, the communication program may be stored in a disk device included in a server device on a network such as the Internet, and be downloaded to a computer. Further, the functions described above may be realized by cooperation between an operating system (OS) and application software. In this case, the part other than the OS may be stored in a medium and distributed, or the part other than the OS may be stored in the server device and downloaded to a computer.

Further, among the respective processing described in the above-described embodiments, all or some of the processing described as being automatically performed can be manually performed. Alternatively, all or some of the processing described as being manually performed can be automatically performed by a known method. In addition, the processing procedures, specific names, information including various data and parameters illustrated in the specification and drawings can be arbitrarily changed unless otherwise specified. For example, various pieces of information illustrated in the drawings are not limited to those illustrated in the drawings.

Further, each illustrated component of each device is functionally conceptual, and does not necessarily have to be configured physically as illustrated in the drawings. That is, the specific modes of distribution/integration of the respective devices are not limited to those illustrated in the drawings. All or some of the devices can be functionally or physically distributed/integrated in any arbitrary unit, depending on various loads or the usage status.

Further, the above-described embodiments can be appropriately combined as long as the processing contents do not contradict each other. Further, the order of each step illustrated in the sequence diagram or the flowchart of the present embodiment can be changed as appropriate.

### 6. Conclusion

Although the respective embodiments of the present disclosure have been described above, the technical scope of the present disclosure is not limited to the above-described embodiments, and various modifications can be made without departing from the scope of the present disclosure. Moreover, components of different embodiments and modified examples may be appropriately combined.

Further, the effects in each embodiment described in the present specification are merely examples. The effects of the present disclosure are not limited thereto, and other effects may be obtained.

Note that the present technology can also have the following configurations.

(1)

A control device connected to a plurality of processing devices and a base station device via a network, the control device comprising:

a control unit that acquires information regarding processing qualities of the plurality of processing devices and

that selects, based on the acquired information regarding the processing qualities, the processing device that is to execute at least one of functions of a core network connected to the base station device from among the plurality of processing devices.

(2)

The control device according to (1), wherein the information regarding the processing qualities includes information regarding latency between the processing device and the base station device.

(3)

The control device according to (2), wherein the information regarding the latency between the processing device and the base station device is information regarding a predetermined position between the processing device and the base station device and latency between the processing devices.

(4)

The control device according to (3), wherein

the base station device, the plurality of processing devices, and the control device are independently connected to different networks, and

the predetermined position between the processing device and the base station device is a connection point that connects the different networks to each other.

(5)

The control device according to any one of (1) to (4), wherein the information regarding the processing qualities includes information regarding a processing speed of the processing device.

(6)

The control device according to any one of (1) to (5), wherein the information regarding the processing qualities includes information regarding a capacity of the processing device.

(7)

The control device according to any one of (1) to (6), wherein the control unit

causes at least one of the processing device connected to a first network that is the same as the first network to which the base station device is connected or the processing device connected to a second network that is different from the first network to execute at least one of the functions of the core network.

(8)

The control device according to any one of (1) to (7), wherein the control unit

selects the function to be executed by the selected processing device according to the processing quality required when the function of the core network is executed.

(9)

The control device according to any one of (1) to (8), wherein the control unit

reselects, in a case where the information regarding the processing qualities of the plurality of processing devices is updated, the processing device that is to execute the function from among the plurality of processing devices based on the updated processing qualities.

(10)

A base station device connected to a plurality of processing devices via a network, the base station device comprising:

a control unit that acquires device information regarding the processing device selected from among the plurality of processing devices based on information regarding processing qualities of the plurality of processing devices, and

that is connected to a core network of which at least one function is executed by the processing device based on the acquired device information.

(11)

A control method performed by a control device connected to a plurality of processing devices and a base station device via a network, the control method comprising:

acquiring information regarding processing qualities of the plurality of processing devices; and

selecting, based on the acquired information regarding the processing qualities, the processing device that is to execute at least one of functions of a core network connected to the base station device from among the plurality of processing devices.

(12)

A connection method in which a base station device connected to a plurality of processing devices via a network is connected to a core network, the connection method comprising:

acquiring device information regarding the processing device selected from among the plurality of processing devices based on information regarding processing qualities of the plurality of processing devices; and

establishing connection to the core network of which at least one function is executed by the processing device based on the acquired device information.

### REFERENCE SIGNS LIST

20 NETWORK
221 AUTHENTICATION DEVICE
222 MANAGEMENT DEVICE
223 CONTROL DEVICE
240 CLOUD SERVER
260 BASE STATION DEVICE
280 MOBILE DEVICE

1. A control device connected to a plurality of processing devices and a base station device via a network, the control device comprising:
a control unit that acquires information regarding processing qualities of the plurality of processing devices and
that selects, based on the acquired information regarding the processing qualities, the processing device that is to execute at least one of functions of a core network connected to the base station device from among the plurality of processing devices.

2. The control device according to claim 1, wherein the information regarding the processing qualities includes information regarding latency between the processing device and the base station device.

3. The control device according to claim 2, wherein the information regarding the latency between the processing device and the base station device is information regarding a predetermined position between the processing device and the base station device and latency between the processing devices.

4. The control device according to claim 3, wherein
the base station device, the plurality of processing devices, and the control device are independently connected to different networks, and
the predetermined position between the processing device and the base station device is a connection point that connects the different networks to each other.

5. The control device according to claim 1, wherein the information regarding the processing qualities includes information regarding a processing speed of the processing device.

6. The control device according to claim 1, wherein the information regarding the processing qualities includes information regarding a capacity of the processing device.

7. The control device according to claim 1, wherein the control unit
causes at least one of the processing device connected to a first network that is the same as the first network to which the base station device is connected or the processing device connected to a second network that is different from the first network to execute at least one of the functions of the core network.

8. The control device according to claim 7, wherein the control unit
selects the function to be executed by the selected processing device according to the processing quality required when the function of the core network is executed.

9. The control device according to claim 1, wherein the control unit
reselects, in a case where the information regarding the processing qualities of the plurality of processing devices is updated, the processing device that is to execute the function from among the plurality of processing devices based on the updated processing qualities.

10. A base station device connected to a plurality of processing devices via a network, the base station device comprising:
a control unit that acquires device information regarding the processing device selected from among the plurality of processing devices based on information regarding processing qualities of the plurality of processing devices, and
that is connected to a core network of which at least one function is executed by the processing device based on the acquired device information.

11. A control method performed by a control device connected to a plurality of processing devices and a base station device via a network, the control method comprising:
acquiring information regarding processing qualities of the plurality of processing devices; and
selecting, based on the acquired information regarding the processing qualities, the processing device that is to execute at least one of functions of a core network connected to the base station device from among the plurality of processing devices.

12. A connection method in which a base station device connected to a plurality of processing devices via a network is connected to a core network, the connection method comprising:
acquiring device information regarding the processing device selected from among the plurality of processing devices based on information regarding processing qualities of the plurality of processing devices; and
establishing connection to the core network of which at least one function is executed by the processing device based on the acquired device information.
